(19) United States
(12) Patent Application Publication
(10) Pub. No.: US 2026/0024007 A1
(43) Pub. Date: Jan. 22, 2026

(54) METHOD AND SYSTEM FOR TRAINING MACHINE LEARNING (ML) MODEL FOR PEAK DETECTION IN FLARING

(71) Applicant: Honeywell International Inc., Charlotte, NC (US)

(72) Inventors: Junda Zhu, Atlanta, GA (US); Sabina Azizli, Fulshear, TX (US); Aishwarya Coffey, Dublin (IE); Sahil Vartak, Atlanta, GA (US); Vijay Kumar Ravi, Atlanta, GA (US); Rakesh Venuturumilli, Phoenix, AZ (US); Tarun Mirani, Woodstock, GA (US)

(21) Appl. No.: 18/776,287

(22) Filed: Jul. 18, 2024

(51) Int. Cl. G06N 20/00; F23G 7/08

(52) U.S. Cl. CPC G06N 20/00; F23G 7/085

(57) ABSTRACT

A method for training a machine learning (ML) model for peak detection in flaring is disclosed. The method comprises receiving, via least one processor, historical flare data associated with one or more flare stacks over a predefined time period; training, via least one processor, an artificial intelligence (AI)/machine learning (ML) model, based at least on the historical data, predefined definitions of flaring, and labeled flare data; determining, via least one processor, one or more peaks in the flaring using the trained AI/ML model; identifying, via least one processor, one or more parameters associated with each of the one or more peaks; determining, via least one processor, whether the one or more parameters satisfy predefined parameters; and deploying, via least one processor, the trained AI/ML model for managing the flaring upon determining the one or more parameters associated with each of the one or more peaks satisfy the predefined parameters.

### TECHNOLOGICAL FIELD

The present invention relates to an industrial control network, and more particularly relates to a system and a method for training a machine learning (ML) model for peak detection in flaring.

### BACKGROUND

In various industrial production facilities, especially in oil and gas facility, managing flaring events is a crucial component of maintaining operational safety and regulatory compliance. Flaring involves a controlled burning of excess gases during production, processing, or refining in production facilities. Further, the flaring prevents buildup of potentially hazardous pressures and disposes of gases that cannot be processed or sold. Further, detection of anomalous flaring events in the facilities is hard, and hinders understanding of emissions within the industrial production facility. The detection of anomalous flaring events is hard because engineers deployed in the facility must plot data related to flaring daily and visually scout for peaks which is a time-consuming process. Further, existing semi auto-machine learning (ML) tools for engineers require engineers to invest time in building and customizing detection capabilities which remain limited.

Additionally, engineers need to gauge the trajectory of normal flaring, whether the flaring is increasing or decreasing over the time, to assess the effectiveness of sustainability initiatives, and to detect underlying issues, such as leaking valves, that might go unnoticed. While gauging the trajectory, noisy data that is associated with the flaring, is cluttered with erratic readings and inconsistencies. Further, unplanned or emergency flaring events distort the picture of the baseline and extracting meaningful baseline is labor-intensive and leads to over-customization. Also, it is difficult to discern the planned emergency flaring from unplanned emergency flaring, and finding the root cause of the unplanned emergency flaring. This impacts both visibility and understanding of flaring drivers. As a result, the approach to managing the flaring events is labor-intensive and time-consuming, requiring operations teams or engineers to manually detect and investigate each flaring event. The manual process not only demands significant labor resources but also increases the risk of inefficiencies and errors, which can have serious safety, environmental, and regulatory implications, and some flaring events might be overlooked or unknown due to inefficiency.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a method for training a machine learning (ML) model for peak detection in flaring is disclosed. The method comprises receiving, via at least one processor, historical flare data associated with one or more flare stacks over a predefined time period. The historical flare data comprises at least one of mass or volume of gas flared within each of the one or more flare stacks, temperature of the gas flared, and pressure at which the gas is flared. Further, the method comprises training, via the at least one processor, an artificial intelligence (AI)/machine learning (ML) model, based at least on the historical data, predefined definitions of flaring, and labeled flare data. The labeled flare data correspond to tagging of peaks in flaring using a predefined value associated with the flaring. Further, the method comprises determining, via the at least one processor, one or more peaks in the flaring using the trained AI/ML model. The one or more peaks correspond to a maximum value of a peak exceeding a predefined threshold value of the peak for the predefined time period. Further, the method comprises identifying, via the at least one processor, one or more parameters associated with each of the one or more peaks. Further, the method comprises determining, via the at least one processor, whether the one or more parameters associated with each of the one or more peaks satisfy predefined parameters. Thereafter, the method comprises deploying, via the at least one processor, the trained AI/ML model for managing the flaring upon determining the one or more parameters associated with each of the one or more peaks satisfy the predefined parameters.

In some embodiments, the at least one processor is configured to train the AI/ML model by determining, via the at least one processor, one or more points from the historical flare data using the AI/ML model, based at least on a threshold value; filtering, via the at least one processor, a subset of points from the determined one or more points based at least on one or more parameters, wherein the one or more parameters comprises at least one of median or standard deviation of values present within the historical flare data for the predefined time period; and clustering, via the at least one processor, the filtered subset of points using the AI/ML model, based at least on one or more time stamps, to form one or more clusters of the filtered subset of points.

In some embodiments, the one or more clusters having one or more parameters. The one or more parameters comprise at least one of a group number, a start time, an end time, duration, peak time, or flare quantity.

In some embodiments, the labelled flare data comprises one or more tags. The one or more tags comprise at least one of tag indicating reading from one or more sensors associated with the one or more flare stacks, tag indicating waste gas flow, tag indicating liquid level of the flare, tag indicating header pressure of the flare, tag indicating temperature of the flare, or tag indicating flare values.

In some embodiments, the predefined definitions of flaring correspond to a predefined meaning of a non-routine flaring and an emergency flaring occurred within the one or more flare stacks. The predefined parameters correspond to a minimum degree of accuracy that is acceptable for determining the non-routine flaring and the emergency flaring for the one or more flare stacks. The one or more parameters associated with each of the one or more peaks comprise at least one of start time and stop time of each of the one or more peaks.

In some embodiments, the method further comprises determining, via the at least one processor, the emergency flaring or the non-routine flaring, using the trained AI/ML model based at least on the predefined definitions of flaring. The emergency flaring corresponds to controlled burning of gas in the flaring due to unexpected or emergency situation.

In some embodiments, the method further comprises correlating, via the at least one processor, other historical flare data with the one or more peaks determined in the flaring upon determining the one or more parameters associated with each of the one or more peaks does not satisfy the predefined parameters. Further, the method comprises selecting, via the at least one processor, a subset of data from the correlated historical flare data with the one or more peaks determined in the flaring, satisfying the predefined parameters. Thereafter, the method comprises retraining, via the at least one processor, the trained AI/ML model with the selected subset of data from the correlated historical flare data with the one or more peaks determined in the flaring.

In some embodiments, the method further comprises eliminating, via the at least one processor, the one or more peaks from the historical flare data based at least on the one or more parameters associated with the one or more peaks. Thereafter, the method comprises determining, via the at least one processor, a baseline curve using the trained AI/ML model for the predefined time period, based at least on the eliminated one or more peaks.

In some embodiments, the predefined value associated with the flaring corresponds to a value of 1 for non-routine flaring and a value of 0 for route flaring. In some embodiments, the predefined time period comprises at least one of hours, days, months, quarters, or years.

In another example embodiment, a system for training a machine learning (ML) model for peak detection in flaring is disclosed. The system comprises a memory and at least one processor communicatively coupled to the memory. The at least one processor is configured to receive historical flare data associated with one or more flare stacks over a predefined time period, wherein the historical flare data comprises at least one of mass or volume of gas flared within each of the one or more flare stacks, temperature of the gas flared, and pressure at which the gas is flared; train an artificial intelligence (AI)/machine learning (ML) model, based at least on the historical data, predefined definitions of flaring, and labeled flare data, wherein the labeled flare data correspond to tagging of peaks in flaring using a predefined value associated with the flaring; determine one or more peaks in the flaring using the trained AI/ML model, wherein the one or more peaks correspond to a maximum value of a peak exceeding a predefined threshold value of the peak for the predefined time period; identify one or more parameters associated with each of the one or more peaks; determine whether the one or more parameters associated with each of the one or more peaks satisfy predefined parameters; and deploy the trained AI/ML model for managing the flaring upon determining the one or more parameters associated with each of the one or more peaks satisfy the predefined parameters.

In yet another example embodiment, a non-transitory machine-readable information storage medium for training a machine learning (ML) model for peak detection in flaring is disclosed. The non-transitory machine-readable information storage medium comprising one or more instructions which when executed by at least one processor cause the at least one processor to receive historical flare data associated with one or more flare stacks over a predefined time period, wherein the historical flare data comprises at least one of mass or volume of gas flared within each of the one or more flare stacks, temperature of the gas flared, and pressure at which the gas is flared; train an artificial intelligence (AI)/machine learning (ML) model, based at least on the historical data, predefined definitions of flaring, and labeled flare data, wherein the labeled flare data correspond to tagging of peaks in flaring using a predefined value associated with the flaring; determine one or more peaks in the flaring using the trained AI/ML model, wherein the one or more peaks correspond to a maximum value of a peak exceeding a predefined threshold value of the peak for the predefined time period; identify one or more parameters associated with each of the one or more peaks; determine whether the one or more parameters associated with each of the one or more peaks satisfy predefined parameters; and deploy the trained AI/ML model for managing the flaring upon determining the one or more parameters associated with each of the one or more peaks satisfy the predefined parameters.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a network diagram of a system for training an artificial intelligence (AI)/machine learning (ML) model for peak detection in flaring in accordance with an example embodiment of the present disclosure;

FIG. 2 illustrates a block diagram of a server in accordance with an example embodiment of the present disclosure;

FIG. 3 illustrates a flowchart showing a method for training an artificial intelligence (AI)/machine learning (ML) model in accordance with an example embodiment of the present disclosure;

FIG. 4 illustrates a flowchart showing a method for hourly categorisation of flaring in accordance with an example embodiment of the present disclosure;

FIG. 5 illustrates a flowchart showing a method for determining a baseline curve in accordance with an example embodiment of the present disclosure;

FIG. 6A illustrates a graph showing the one or more peaks in accordance with an example embodiment of the present disclosure;

FIG. 6B illustrates a graph showing one or more clusters in accordance with an example embodiment of the present disclosure;

FIG. 7A illustrates a graph showing an hourly monitoring in accordance with an example embodiment of the present disclosure;

FIG. 7B illustrates a graph showing a quarterly monitoring in accordance with an example embodiment of the present disclosure;

FIG. 7C illustrates a table showing data related to the quarterly monitoring in accordance with an example embodiment of the present disclosure;

FIGS. 8A-8C illustrate a graph showing emergency flaring in accordance with an example embodiment of the present disclosure;

FIG. 9A illustrates a graph showing shapely additive explanations (SHAP) plot for the trained AI/ML model in accordance with an example embodiment of the present disclosure;

FIG. 9B illustrates a graph showing testing of the trained AI/ML model in accordance with an example embodiment of the present disclosure;

FIG. 10 illustrates a table showing training, validation, and testing results of the trained AI/ML model in accordance with an example embodiment of the present disclosure;

FIGS. 11-13 illustrate graphs showing SHAP values of one or more tags associated with the one or more peaks in accordance with an example embodiment of the present disclosure; and

FIG. 14 illustrates a flowchart showing a method for training the ML model for peak detection in flaring in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

The present disclosure provides various embodiments of methods and systems for training a machine learning (ML) model for peak detection in flaring. Embodiments may be configured to receive historical flare data associated with one or more flare stacks over a predefined time period. The historical flare data may comprise at least one of mass or volume of gas flared within each of the one or more flare stacks, temperature of the gas flared, and pressure at which the gas is flared. Embodiments may be configured to train an artificial intelligence (AI)/machine learning (ML) model, based at least on the historical data, predefined definitions of flaring, and labeled flare data. The labeled flare data may correspond to tagging of peaks in flaring using a predefined value associated with the flaring. Embodiments may be configured to determine one or more peaks in the flaring using the trained AI/ML model. The one or more peaks may correspond to a maximum value of a peak exceeding a predefined threshold value of the peak for the predefined time period. Embodiments may be configured to identify one or more parameters associated with each of the one or more peaks. Embodiments may be configured to determine whether the one or more parameters associated with each of the one or more peaks satisfy predefined parameters. Embodiments may be configured to deploy the trained AI/ML model for managing the flaring upon determining the one or more parameters associated with each of the one or more peaks satisfy the predefined parameters.

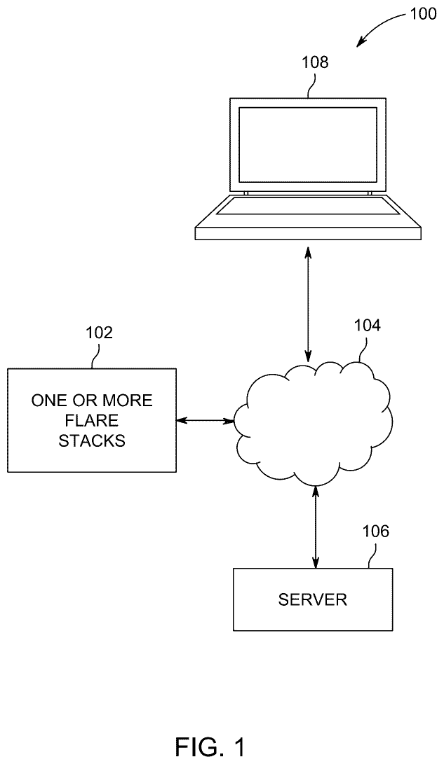

FIG. 1 illustrates a network diagram of a system 100 for training an artificial intelligence (AI)/machine learning (ML) model for peak detection in flaring in one or more flare stacks 102, in accordance with an example embodiment of the present disclosure. The system 100 may comprise a network 104, a server 106, and a user device 108.

In some embodiments, the network 104 may be a communication network, such as internet or a cloud network, configured to enable communication between the one or more flare stacks 102, the server 106, and the user device 108 through wired, wireless, or hybrid connections. Further, the network 104 may also correspond to a distributed infrastructure designed for the exchange of data, information, and resources among interconnected computing devices and systems. The network 104 may facilitate communication and collaboration across remote locations, devices, and platforms. Those skilled in the art will understand that wired devices may include, but are not limited to, wired networks such as wide area networks (WANs) or local area networks (LANs). Further, wireless devices, on the other hand, may use wireless communications via radio frequency (RF) signals or infrared signals. Furthermore, various devices within the system 100 may connect to the network 104 using an array of wired and wireless communication protocols, such as Transmission Control Protocol/Internet Protocol (TCP/IP), User Datagram Protocol (UDP), and 2G, 3G, or 4G communication protocols.

In some embodiments, the system 100 may comprise the one or more flare stacks 102. The one or more flare stacks 102 may be configured to perform flaring of a gas. Further, the flaring may refer to a process of controlled burning of excess gas. In some embodiments, the one or more flare stacks 102 comprises one or more components that may be configured to perform flaring of the gas. Further, the one or more components may comprise a gas collection unit (not shown), a flare header (not shown), a knockout drum (not shown), a flare tip (not shown), a pilot burner (not shown), a steam or an air injection system (not shown), a flame arrestor (not shown), and a monitoring and control unit (not shown). In some embodiments, the gas collection unit of the one or more flare stacks 102 may be configured to collect the excess gas from various parts of a facility from the one or more facilities. In some embodiments, the flare header of the one or more flare stacks 102 may correspond to a piping network that may be configured to transport the collected gas from the gas collection unit to the one or more flare stacks 102. In some embodiments, the knockout drum of the one or more flare stacks 102 may be configured to remove any liquid constituents from the collected gas to prevent liquid carryover into a flare. In some embodiments, the flare tip of the one or more flare stacks 102 may correspond to an end of the one or more flare stacks 102 when the gas is ignited and burned.

In some embodiments, the pilot burner of the one or more flare stacks 102 may be configured to provide a continuous ignition source that facilitates a continuous burning of the gas. In some embodiments, the steam or air injection system may be configured to provide additional oxygen or steam to the one or more flare stacks 102 during combustion of the gas. In some embodiments, the flame arrestor of the one or more flare stacks 102 may be configured to prevent flashbacks of the flare generated during combustion of the gas. In some embodiments, the monitoring and control unit of the one or more flare stacks 102 may be configured to monitor operations of the one or more flare stacks 102 during flaring of the gas. Further, the monitoring and control unit may comprise a temperature sensor (not shown), a pressure sensor (not shown), a flow rate sensor (not shown), etc. In some embodiments, the monitoring and control unit may be configured to generate historical flare data. Further, the historical flare data may correspond to mass or volume of gas flared within each of the one or more flare stacks 102, temperature of the gas flared, and pressure at which the gas is flared. In one example, the flow rate sensor may be configured to detect the mass or volume of the gas flared within each of the one or more flare stacks 102. The temperature sensor may be configured to detect the temperature of the gas flared. The pressure sensor may be configured to detect the pressure at which the gas is flared.

In some embodiments, the one or more flare stacks 102 may be installed at a site (not shown). The one or more flare stacks 102 may serve as a safety mechanism and environmental control for the site. The site may correspond to an oil refinery, a natural gas processing plant, a petrochemical facility, a power plant, a waste management facility, or a pharmaceutical manufacturing site. Flaring may occur at the site for reasons based on each industry's processes. In one example, flaring may be used to burn off excess gas produced during refining crude oil into useful products like gasoline and diesel, at the oil refinery. In another example, the natural gas processing plant may use flaring to safely burn off the excess gases that are not easily processed into products like methane and propane. In yet another example, flaring may handle gases generated during producing chemicals and plastics, preventing the release of the gases into the environment, in the petrochemical facility.

In another example, flaring may occur during maintenance or emergencies to safely release gases from boilers or turbines, at the power plant. In yet another example, waste management facility may use flaring to burn off methane produced by decomposing waste, reducing greenhouse gas emissions. In another example, flaring may handle gases from sterilization and chemical synthesis processes, in pharmaceutical manufacturing. For each site, flaring may be needed for safety, environmental protection, and regulatory compliance, ensuring that gases are managed and disposed of safely. It may be noted that the system 100 is capable of being deployed to other complex industrial processes and environments, or industrial facilities, or sites, having the one or more flare stacks 102 installed.

In some embodiments, the system 100 may further comprise the server 106. The server 106 may correspond to a computer or software module that is configured to provide centralized resources, data, or services to the one or more flare stacks 102. The server 106 may be configured to handle and manage one or more computational tasks and data processing within the system 100. In some embodiments, the server 106 may include storage systems, such as hard drives or storage arrays, to store and manage large volumes of data and information accessible to network users. In some embodiments, the server 106 may further provide centralized control and management capabilities, allowing network administrators to configure, monitor, and maintain network resources, security settings, and user access permissions from a single location.

In some embodiments, the server 106 may be configured to receive historical flare data associated with one or more flare stacks 102 over a predefined time period. The historical flare data may comprise at least one of mass or volume of gas flared within each of the one or more flare stacks 102, temperature of the gas flared, and pressure at which the gas is flared. Further, the server 106 may comprise a memory (not shown). The memory may be configured to store the received historical flare data associated with one or more flare stacks 102 over the predefined time period. In one example, the memory may be configured to store one or more instructions that may be executed by the server 106 to perform various operations.

In some embodiments, the server 106 may be configured to train the AI/ML model, based at least on the historical data, predefined definitions of flaring, and labeled flare data. The labeled flare data may correspond to tagging of peaks in flaring using a predefined value associated with the flaring. In some embodiments, the server 106 may be configured to determine one or more peaks in the flaring using the trained AI/ML model. The one or more peaks correspond to a maximum value of a peak exceeding a predefined threshold value of the peak for the predefined time period.

In some embodiments, the server 106 may further be configured to identify one or more parameters associated with each of the one or more peaks. Further, the server 106 may be configured to determine whether the one or more parameters associated with each of the one or more peaks satisfy predefined parameters. Further, the server 106 may be configured to deploy the trained AI/ML model for managing the flaring upon determining the one or more parameters associated with each of the one or more peaks satisfy the predefined parameters.

In some embodiments, the system 100 may comprise the user device 108. Further, the user device 108 may be communicatively coupled to the one or more flare stacks 102 through the network 104. In some embodiments, the user device 108 may be configured to display the one or more peaks in flaring. In some embodiments, the user device 108 may be configured to provide a real-time insight into the one or more peaks and deployment of the trained AI/ML model. Further, the user device 108 may comprise at least one of a mobile phone, tablet, laptop, etc. Further, the user device 108 may be installed with a user interface that may provide a medium to the user to manually provide the emergency flaring or non-routine flaring.

It will be apparent to one skilled in the art that above-mentioned components of the system 100 have been provided only for illustration purposes, without departing from the scope of the disclosure.

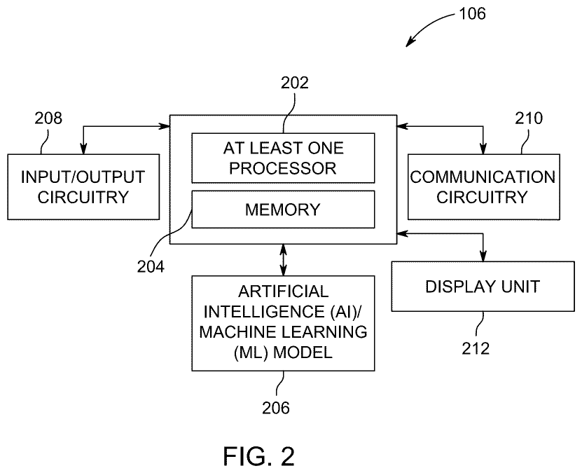

FIG. 2 illustrates a block diagram of the server 106, in accordance with an example embodiment of the present disclosure. FIG. 2 is described in conjunction with FIG. 1.

In some embodiments, the server 106 may comprise at least one processor 202, a memory 204, an artificial intelligence (AI)/machine learning (ML) model 206, an input/output circuitry 208, a communication circuitry 210, and a display unit 212. In some embodiments, the at least one processor 202 may be configured to receive the historical flare data associated with the one or more flare stacks 102 over the predefined time period. The historical flare data may comprise at least one of the mass or volume of the gas flared within each of the one or more flare stacks 102, the temperature of the gas flared, and the pressure at which the gas is flared. The predefined time period may comprise at least one of hours, days, months, quarters, or years. In one example, the mass or volume of gas flared within each of the one or more flare stacks 102 is 800 cubic meters, temperature of the gas flared is 1300 degrees Celsius, and pressure at which the gas is flared is 80 psi. In one example, the historical flare data is determined from one or more sensors (not shown) of the one or more flare stacks 102. Further, the one or more sensors may comprise a flow rate sensor i.e., flow meter, a temperature sensor, and a pressure sensor.

In one example, in an oil refinery have three flare stacks that have been monitored over the past five months. Historical flare data from the three flare stacks includes the mass of gas flared daily, with volumes ranging from 100 to 5000 cubic meters, temperature of the gas flared, ranging between 300° C. and 800° C., and pressure at which the gas is flared, ranging from 1 to 10 bar. The at least one processor 202 first collects the historical flare data, including sensor readings such as waste gas flow rates (ranging from 50 to 2000 cubic meters per hour), liquid levels in the flare stacks, header pressures, and flare temperatures.

In some embodiments, the at least one processor 202 may be configured to train the AI/ML model 206. The AI/ML model 206 may be trained based at least on the historical data, the predefined definitions of flaring, and the labeled flare data. In some embodiments, the predefined definitions of flaring may correspond to a predefined meaning of a non-routine flaring and an emergency flaring occurred within the one or more flare stacks 102. In some embodiments, the at least one processor 202 may be configured to determine the emergency flaring or the non-routine flaring, using the trained AI/ML model 206. The emergency flaring or the non-routine flaring may be determined based at least on the predefined definitions of flaring. The emergency flaring may correspond to controlled burning of the gas in the flaring due to unexpected situation or emergency situation. The non-routine flaring may correspond to a response to unexpected operational issues that may include equipment malfunctions, power outages, or safety hazards. In some embodiments, the non-routine flaring may be conducted during unplanned situations. Further, during the non-routine flaring, the one or more flare stacks 102 may be configured to immediately release and combust the one or more gases.

In some embodiments, the labeled flare data may correspond to the tagging of peaks in flaring using the predefined value associated with the flaring. The predefined value associated with the flaring may correspond to a value of 1 and a value of 0. In one example, the value of 1 may correspond to non-routine flaring. In another example, the value of 0 may correspond to routine flaring. In some embodiments, the labelled flare data may comprise one or more tags. Further, the one or more tags may comprise at least one of a tag indicating reading from the one or more sensors associated with the one or more flare stacks 102, a tag indicating waste gas flow, a tag indicating liquid level of the flare, a tag indicating header pressure of the flare, a tag indicating temperature of the flare, or a tag indicating flare values.

In one example, the tag indicating reading from one or more sensors associated with the one or more flare stacks 102 may correspond to a tag indicating the reading from the flare's flow meter. In another example, the tag may indicate waste gas flow from a channel. In yet another example, the tag may indicate a flare's liquid level. In another example, the tag may indicate indicate a flare header pressure at flame arrestors. In yet another example, the tag may indicate a flare's temperature. In another example, the tag may indicate flare values, for instance, previous 25 flare values, i.e., flare values over the last 500 seconds. In an example embodiment, a tag may indicate upstream parameters detection.

In some embodiments, the AI/ML model 206 may correspond to a random forest model and density-based spatial clustering of applications with noise (DBSCAN) model. In one example, the random forest may correspond to an ensemble learning method that operates by constructing multiple decision trees during training. Each decision tree in the random forest model, independently predicts output, and the final prediction is determined by aggregating the predictions of each decision tree, either by averaging or voting. The random forest model may be used to predict or classify aspects related to the historical flare data. The random forest model may handle both regression and classification tasks effectively by leveraging the collective wisdom of multiple decision trees for the historical flare data. In another example, the DBSCAN may correspond to a clustering method that groups together points that are closely packed together based on a density criterion. The DBSCAN may identify clusters of varying shapes and sizes in the historical flare data, separating the clusters from noise.

Further, the at least one processor 202 may be configured to train the AI/ML model 206 by determining one or more points from the historical flare data using the AI/ML model 206. The one or more points may be determined in time that are part of a peak. The one or more points may be determined based at least on a threshold value. The threshold value may act as a filter, ensuring that only one or more points meeting certain predefined conditions, such as specific emission levels, operational parameters, or other relevant factors, are considered in training of the AI/ML model 206. By applying the threshold value, the AI/ML model 206 may focus on significant one or more points that contribute to accurate predictions or classifications related to flaring, optimizing the training process and enhancing the effectiveness of the AI/ML model 206 in analyzing and mitigating flare incidents in industrial settings. In one example, the threshold value for the AI/ML model 206 is 0.245.

Further, the at least one processor 202 may be configured to train the AI/ML model 206 by filtering a subset of points from the determined one or more points based at least on one or more parameters. The one or more parameters may comprise at least one of median or standard deviation of values present within the historical flare data for the predefined time period. Thereafter, the at least one processor 202 may be configured to train the AI/ML model 206 by clustering the filtered subset of points using the AI/ML model 206, to form one or more clusters of the filtered subset of points. The filtered subset of points may be clustered based at least on one or more time stamps. The one or more clusters may be formed using the DBSCAN model. The one or more clusters may comprise one or more parameters. Further, the one or more parameters may comprise at least one of a group number, a start time, an end time, duration, peak time, or flare quantity. In one example, the group number may be denoted as “group_no” corresponding to unique cluster number for a day. The group number may be used to calculate total unique peaks throughout the day. In another example, the start time may be denoted as “start_time” corresponding to minimum time identified within each “group_no”. In yet another example, the end time may be denoted as “end time” corresponding to maximum time identified within each group_no. In another example, the duration may be denoted as “duration_seconds” corresponding to end_time-start_time (in seconds). In yet another example, the peak time may be denoted as “peak_time” corresponding to a time at which the flow meter's reading was maximum. In another example, the flare quantity may be denoted as “flare_quantity” corresponding to sum of volume flared between the start time and the end time.

In one example, the collected historical data is then used to train an AI/ML model 206, such as a random forest model and a DBSCAN model. The training process involves labeled flare data, where peaks in flaring are tagged. For instance, an event of non-routine flaring is tagged with a value of 1, while an event of routine flaring is tagged with a value of 0. Further, the at least one processor 202 identifies one or more points from the historical flare data that exceed a threshold value, say flaring where the gas volume surpasses 3000 cubic meters.

The one or more points are then filtered based on parameters such as the median and standard deviation of the historical data values present in the historical data over the five-month period to get a subset of points. For example, if the median flaring volume is 2500 cubic meters and the standard deviation is 700 cubic meters, the trained AI/ML model 206 filters out events that do not deviate significantly from these metrics. The filtered subset of points is clustered into groups using one or more time stamps, forming one or more clusters that detail events with specific start time, end time, duration, peak time, and flare quantity. For instance, a cluster might indicate a non-routine flaring event that started at 3:00 PM, peaked at 4:00 PM with a volume of 4000 cubic meters, and ended at 5:00 PM.

In some embodiments, the at least one processor 202 may be configured to determine the one or more peaks in the flaring using the trained AI/ML model 206. The one or more peaks may be determined using the random forest model of the trained AI/ML model 206. The one or more peaks may correspond to the maximum value of the peak exceeding the predefined threshold value of the peak for the predefined time period. The predefined threshold value of the peak may correspond to a predetermined limit set for the maximum intensity or magnitude of the peak identified in flaring for the predefined time period. The predefined threshold value may serve as a criterion against which the AI/ML model 206 is trained to determine one or more peaks in the flaring to evaluate severity or significance of each peak of the one or more peaks. When intensity of a peak may surpass the predefined threshold value during the predefined time period, a potential notable flare event or an emission spike may be indicated that may require further attention or action. The predefined threshold value may help in identifying and prioritizing significant flare incidents based on intensity of the peak, thereby aiding in timely response and mitigation efforts within the one or more flare stacks 102. For example, upon training the AI/ML model 206, the at least one processor 202 determines one or more peaks in the flaring that exceed a predefined threshold value, such as a peak flaring volume of 4500 cubic meters.

In some embodiments, the at least one processor 202 may be configured to identify the one or more parameters associated with each of the one or more peaks. The one or more parameters associated with each of the one or more peaks may comprise at least one of start time and stop time of each of the one or more peaks. In some embodiments, the at least one processor 202 may be configured to eliminate the one or more peaks from the historical flare data based at least on the one or more parameters associated with the one or more peaks. Thereafter, the at least one processor 202 may be configured to determine a baseline curve using the trained AI/ML model 206 for the predefined time period. The baseline curve may be determined based at least on the eliminated one or more peaks. In one example, one or more parameters associated with the peak flaring volume of 4500 cubic meters, including start time and stop time. The at least one processor 202 eliminates identified one or more peaks from the historical flare data and determines a baseline curve for the predefined time period, such as the five months of data, using the trained AI/ML model 206. In some embodiments, the baseline curve may be configured to represent a normal or an expected level of flaring over the predefined time period, adjusted by eliminating the one or more peaks from the historical flare data based at least on the one or more parameters.

In some embodiments, the at least one processor 202 may be configured to determine whether the one or more parameters associated with each of the one or more peaks satisfy the predefined parameters. The predefined parameters may correspond to a minimum degree of accuracy that is acceptable for determining the non-routine flaring and the emergency flaring for the one or more flare stacks 102. In some embodiments, the at least one processor 202 may be configured to deploy the trained AI/ML model for managing the flaring upon determining the one or more parameters associated with each of the one or more peaks satisfy the predefined parameters. In some embodiments, the deployed AI/ML model 206 may provide accurate flaring detection that accounts for holistic flare data i.e., historical flare data. In one example, the flaring may be detected with approximately 91 percent (%) accuracy.

For example, the one or more parameters associated with the peak flaring volume of 4500 cubic meters are evaluated against predefined parameters. Once the trained AI/ML model 206 is adequately trained and the one or more parameters associated with the peak satisfy the minimum degree of accuracy of 80%, the trained AI/ML model 206 is deployed for managing flaring.

In some embodiments, the at least one processor 202 may be configured to correlate other historical flare data with the one or more peaks determined in the flaring upon determining the one or more parameters associated with each of the one or more peaks does not satisfy the predefined parameters. Further, the at least one processor 202 may be configured to select a subset of data from the correlated historical flare data with the one or more peaks determined in the flaring, satisfying the predefined parameter. In one example, if the one or more parameters do not meet the predefined parameters, the at least one processor 202 correlates additional historical flare data with the one or more peaks and selects a subset of data from the correlated historical flare data. In some embodiments, the additional historical flare data may correspond to supplementary flare data apart from the historical flare data, to provide additional information about determined one or more peaks in the historical flaring data. In some embodiments, the subset of data may correspond to a specific portion or segment of the correlated historical flare data that meets the predefined parameters, selected for further analysis in the historical flare data that is under consideration.

Thereafter, the at least one processor 202 may be configured to retrain the trained AI/ML model 206 with the selected subset of data from the correlated historical flare data with the one or more peaks determined in the flaring. For example, the at least one processor 202 retrains the trained AI/ML model 206 with the selected subset of data. Further, the at least one processor 202 may utilize the trained AI/ML model 206 to identify emergency or non-routine flaring events based on predefined definitions of flaring. For example, an emergency flaring event, identified by a sudden spike in gas volume due to an unexpected situation like a safety valve release, can be distinguished from routine operational flaring.

In some embodiments, the at least one processor 202 may include suitable logic, circuitry, and/or interfaces that are operable to execute one or more instructions stored in the memory 204 to perform predetermined operations. In one embodiment, the at least one processor 202 may be configured to decode and execute any instructions received from one or more other electronic devices or server(s). The at least one processor 202 may be configured to execute one or more computer-readable program instructions, such as program instructions to carry out any of the functions described in this description. Further, the at least one processor 202 may be implemented using one or more processor technologies known in the art. Examples of the at least one processor 202 include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In some embodiments, the memory 204 may be configured to store a set of instructions and data executed by the at least one processor 202. Further, the memory 204 may include the one or more instructions that are executable by the at least one processor 202 to perform specific operations. The memory 204 may be configured to include the instructions to receive the historical flare data associated with the one or more flare stacks 102 over the predefined time period. The memory 204 may be configured to include the instructions to train the AI/ML model 206, based at least on the historical data. Further, the memory 204 may be configured to include the instructions to determine the one or more peaks in the flaring using the trained AI/ML model 206. The memory 204 may be configured to include the instructions to identify the one or more parameters associated with each of the one or more peaks. The memory 204 may be configured to include the instructions to determine whether the one or more parameters associated with each of the one or more peaks satisfy the predefined parameters. The memory 204 may be configured to include the instructions to deploy the trained AI/ML model for managing the flaring upon determining the one or more parameters associated with each of the one or more peaks satisfy the predefined parameters.

The memory 204 may be configured to include the instructions to correlate other historical flare data with the one or more peaks determined in the flaring upon determining the one or more parameters associated with each of the one or more peaks does not satisfy the predefined parameters. The memory 204 may be configured to include the instructions to select the subset of data from the correlated historical flare data with the one or more peaks determined in the flaring, satisfying the predefined parameter. The memory 204 may be configured to include the instructions to retrain the trained AI/ML model 206 with the selected subset of data from the correlated historical flare data with the one or more peaks determined in the flaring. It is apparent to a person with ordinary skill in the art that the one or more instructions stored in the memory 204 enable the hardware of the server 106 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the server 106 may further comprise the input/output circuitry 208. The input/output circuitry 208 may enable the one or more users to communicate or interface with the server 106, via the user device 108. The user device 108 may include N number of user devices. In some embodiments, the input/output circuitry 208 may act as a medium to transmit input from the interface to and from the server 106. In some embodiments, the input/output circuitry 208 may refer to the hardware and software components that facilitate the exchange of information between the user device 108 and the server 106. In one example, the user device 108 may include a graphical user interface (GUI) (not shown) as an input circuitry to allow the one or more users to input the predefined value associated with the flaring. The input/output circuitry 208 may include various input devices such as keyboards, barcode scanners, GUI for the one or more users to provide data and various output devices such as displays, printers for the one or more users to receive the historical flare data. In another example, the input/output circuitry 208 may include various output circuitry such as a display to show the emergency flaring or the non-routine flaring.

In some embodiments, the server 106 may further comprise the communication circuitry 210. The communication circuitry 210 may allow the server 106 to exchange data or information with other systems or apparatuses. Further, the communication circuitry 210 may include network interfaces, protocols, and software modules responsible for sending and receiving data or information. In some embodiments, the communication circuitry 210 may include Ethernet ports, Wi-Fi adapters, or communication protocols like HTTP or MQTT for connecting with other systems. The communication circuitry 210 may further include components such as communication modules (e.g., Wi-Fi, Ethernet, cellular), transceivers, antennas, and protocols (e.g., TCP/IP, MQTT, SNMP) for exchanging data with other systems or network devices. The communication circuitry 210 may allow the server 106 to stay up-to-date and accurately determine and track the emergency flaring or the non-routine flaring.

In some embodiments, the server 106 may further comprise the display unit 212. The at least one processor 202 may be configured to display accuracy of the trained AI/ML model 206, to the user on the display unit 212. Further, the at least one processor 202 may be configured to display the received historical flare data, to the user on the display unit 212. Further, the at least one processor 202 may be configured to display the output related to determination of the one or more peaks in the historical flare data from deployed AI/ML model 206, to the user on the display unit 212. The trained AI/ML model 206 may be sent on the display unit 212 for managing the flaring upon determining the one or more parameters associated with each of the one or more peaks satisfy the predefined parameters. In some embodiments, the display unit 212 may further include a smartphone, a tablet, a laptop, a personal computer (PC), a smart watch or any other computing device having the display unit 212 known in the art. In one embodiment, the user may use the smartphone or the tablet as a device to receive the trained AI/ML model 206 on the display unit 212. In another embodiment, a dedicated Android or IOS application may be developed to interact with the one or more flare stacks 102, via the display unit 212. In some embodiments, the display unit 212 may be installed with a graphical user interface (GUI). In some embodiments, the GUI of the display unit 212 may be configured to visually and audibly notify the user of the emergency flaring or the non-routine flaring by visual alerts, auditory alerts, textual alerts, textual alerts, tactile alerts, or remote alerts.

It will be apparent to one skilled in the art the above-mentioned components of the server 106 have been provided only for illustration purposes, without departing from the scope of the disclosure.

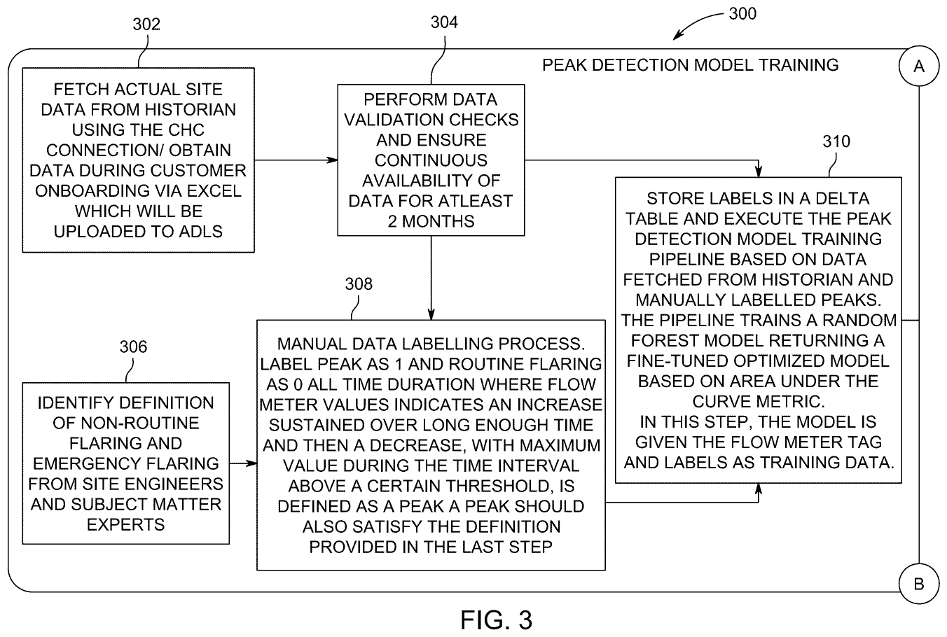

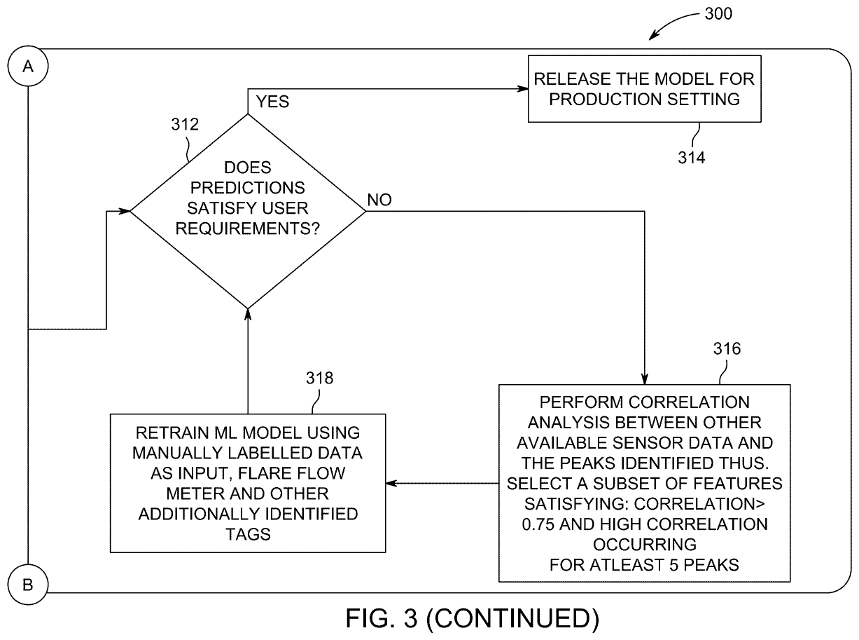

FIG. 3 illustrates a flowchart showing a method 300 for training the AI/ML model 206, in accordance with an example embodiment of the present disclosure. FIG. 3 is described in conjunction with FIGS. 1-2.

In some embodiments, the method 300 for training the AI/ML model 206 may correspond to peak detection model training. At operation 302, the at least one processor 202 may be configured to fetch actual size data from historian using the cargo heat controller (CHC) connection, or obtain data during user onboarding via excel uploaded to azure data lake storage (ADLS). In some embodiments, the actual size data from historian may correspond to the historical flare data over the predefined time period.

In one example, in an oil refinery with three flare stacks that have been monitored over the past six months. A historical flare data from the three flare stacks includes the mass of gas flared daily, with volumes ranging from 150 to 5050 cubic meters, temperature of the gas flared, between 350° C. and 850° C., and pressure at which the gas is flared, varying from 1.2 to 11 bar. The at least one processor 202 first collects the historical flare data, including sensor readings such as waste gas flow rates (ranging from 55 to 2050 cubic meters per hour), liquid levels in the flare stacks, header pressures, and flare temperatures.

At operation 304, the at least one processor 202 may be configured to perform data validation checks and ensure continuous availability of data for at least two months. The at least one processor 202 may be configured to perform data validation checks on the fetched or received historical flare data. In some embodiments, the at least one processor 202 may be configured to validate the received historical flare data by verifying data integrity, consistency, and adherence to ensure accurate and reliable historical flare data for subsequent analyses and operation. In some embodiments, the at least one processor may be configured to ensure that the historical flare data is received for a predefined time period. The predefined time period corresponds to a minimum time duration for which the historical flare data is required for training the AI/ML model. In one example, the predefined time period is 2 months.

For example, the at least one processor 202 is configured to perform data validation checks and ensure continuous availability of data for at least two months for the historical flare data including the mass of gas flared daily, with volumes ranging from 150 to 5050 cubic meters, temperature of the gas flared, between 350° C. and 850° C., and pressure at which the gas is flared, varying from 1.2 to 11 bar

At operation 306, the at least one processor 202 may be configured to identify definition of non-routine flaring and emergency flaring from site engineers and subject matter experts. The definition of non-routine flaring may correspond to the predefined definition of flaring that corresponds to the predefined meaning of the non-routine flaring within the one or more flare stacks 102. The definition of emergency flaring may correspond to the predefined definition of flaring that corresponds to the predefined meaning of the emergency flaring occurred within the one or more flare stacks 102. For example, the at least one processor 202 identifies non-routine flaring as instances where flare volumes exceed 500 cubic meters per hour, based on input from site engineers and subject matter experts, while emergency flaring is defined as flaring events lasting longer than 30 minutes due to equipment malfunction.

At operation 308, the at least one processor 202 may be configured to manually label the fetched actual size data. The manually labelled fetched actual size data may correspond to the labeled flare data that further corresponds to tagging of peaks in flaring using the predefined value associated with the flaring label. In one example, the predefined value associated with the flaring may correspond to the value of 1 for non-routine flaring and the value of 0 for routine flaring. In some embodiments, all time duration where flow meter values indicate an increase sustained over long enough time and then a decrease, with maximum value during the time interval i.e., the predefined time period, above the predefined threshold value, may be defined as the peak.

At operation 310, the at least one processor 202 may be configured to store the labels in a delta table and execute the peak detection model training pipeline based on data fetched from historian and manually labelled peaks. The labels may correspond to the fetched actual size data that is manually labelled. The peak detection model training pipeline may train the random forest model returning a fine-tuned optimized model based on area under the curve metric. Further, the fine-tuned optimized model may be given the flow meter tag and labels as the training data to determine one or more peaks in the flaring. The flow meter tag may correspond to the tag indicating reading from one or more sensors associated with the one or more flare stacks 102. Further, the labels as the training data may correspond to the labelled flare data. Then, the at least one processor 202 may be configured to identify the one or more parameters associated with each of the one or more peaks.

For example, the collected historic data is then used to train an AI/ML model 206, such as a random forest model and a DBSCAN model. The training process involves labeled flare data, where peaks in flaring are tagged. For instance, an event of non-routine flaring is tagged with a value of 1, while an event of routine flaring is tagged with a value of 0. Further, the at least one processor 202 identifies one or more points from the historical flare data that exceed a threshold value, say flaring where the gas volume surpasses 4000 cubic meters. Furthermore, upon training the AI/ML model 206, the at least one processor 202 determines one or more peaks in the flaring that exceed a predefined threshold value, such as a peak flaring volume of 4550 cubic meters. Then, one or more parameters associated with the peak flaring volume of 4550 cubic meters, including start time and stop time.

At operation 312, the at least one processor 202 may be configured to determine whether predictions satisfy user requirements. In some embodiments, the at least one processor 202 may be configured to determine whether predictions performed by the AI/ML model 206, satisfy user requirements. Further, determining whether predictions performed by the AI/ML model 206, satisfy user requirements may correspond to determining whether the one or more parameters associated with each of the one or more peaks satisfy predefined parameters. Herein, the user requirements may correspond to the predefined parameters. In one case, when the predictions satisfy the user requirement, the at least one processor 202 may be configured to release the trained AI/ML model 206 for production setting, at operation 314. In some embodiments, the release of the AI/ML model 206 for production setting may correspond to deploying the trained AI/ML model 206 for managing the flaring.

For example, the one or more parameters associated with the peak flaring volume of 4550 cubic meters are evaluated against predefined parameters. Once the trained AI/ML model 206 is adequately trained and the one or more parameters associated with the peak satisfy the minimum degree of accuracy, the trained AI/ML model 206 is deployed for managing flaring.

In another case, when the prediction does not satisfy the customer requirement, the at least one processor 202 may be configured to perform correlation analysis between other available sensor data and the peaks identified, at operation 316. In some embodiments, the at least one processor 202 may be configured to correlate other historical flare data with the one or more peaks determined in the flaring. Further, the at least one processor 202 may be configured to select the subset of data from the correlated historical flare data with the one or more peaks determined in the flaring, satisfying the predefined parameter. The selection of the subset of data from the correlated historical flare data may correspond to selecting a subset of features satisfying correlation greater than 0.75, and high correlation occurring for at least five peaks.

For example, if the one or more parameters do not meet the predefined parameters, the at least one processor 202 correlates additional historical flare data with the one or more peaks and selects a subset of data from the correlated historical flare data.

At operation 318, the at least one processor 202 may be configured to retrain the ML model using manually labelled data as input, flare flow meter and other additionally identified tags. In some embodiments, retraining the ML model using manually labelled data as input, flare flow meter and other additionally identified tags may correspond to retraining the trained AI/ML model 206 with the selected subset of data from the correlated historical flare data with the one or more peaks determined in the flaring. For example, the at least one processor 202 retrains the trained AI/ML model 206 with the selected subset of data for the oil refinery.

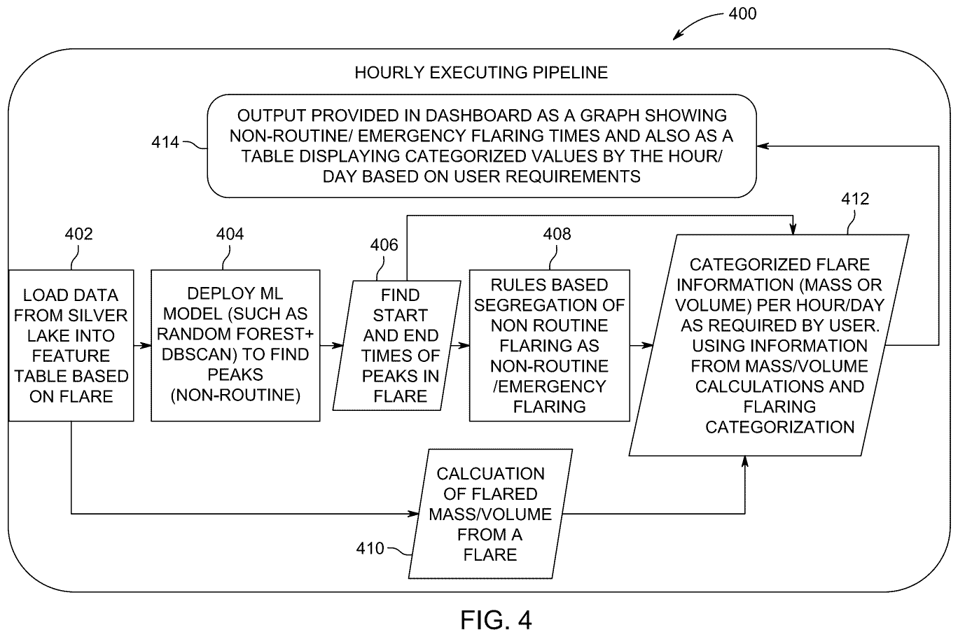

FIG. 4 illustrates a flowchart showing a method 400 for hourly categorisation of flaring by using the trained AI/ML model 206, in accordance with an example embodiment of the present disclosure. FIG. 4 is described in conjunction with FIGS. 1-3.

In some embodiments, the method 400 for hourly categorisation of flaring using the AI/ML model 206 may correspond to hourly executing pipeline. At operation 402, the at least one processor 202 may be configured to load data from a repository of data (i.e., a silver lake) into a feature table based on flare. The data may correspond to historical flare data. The feature table may be denoted as “ai_catalog.fip_dev_ai_sus_staging.ml_flare_pivot” comprising information on the one or more tags. At operation 404, the at least one processor 202 may be configured to deploy the AI/ML model 206 to find peaks in non-routine flaring. The ML model may correspond to the trained AI/ML model 206. In some embodiments, finding peaks in non-routine flaring may correspond to determining one or more peaks in the flaring using the trained AI/ML model 206.

At operation 406, the at least one processor 202 may be configured to find start and end times of peaks in flare. The start and end times of peaks may correspond to the start time and the end time associated with the identified one or more parameters that are identified by the at least one processor 202. At operation 408, the at least one processor 202 may be configured to perform rule based segregation non-routine flaring as non-routine or emergency flaring. The at least one processor 202 may be configured to perform rule based segregation based at least on the start and end times in flare.

At operation 410, the at least one processor 202 may be configured to calculate flared mass or volume from a flare. In some embodiments, the flared mass/volume from the flare may correspond to the mass or volume of gas flared within each of the one or more flare stacks 102. The operation 410 may be performed simultaneously with the operation 402, by the at least one processor 202. At operation 412, the at least one processor 202 may be configured to categorize flare information (mass or volume) per hour/day as required by user. In some embodiments, the flare information may be categorized based at least on the calculate flared mass or volume, start and end times of peaks, and segregated non-routine flaring. At operation 414, the at least one processor 202 may be configured to provide output in dashboard as a graph showing non-routine or emergency flaring times and also as a table displaying categorized values by the hour/day based on user requirements. In some embodiments, the output may comprise the categorized flare information.

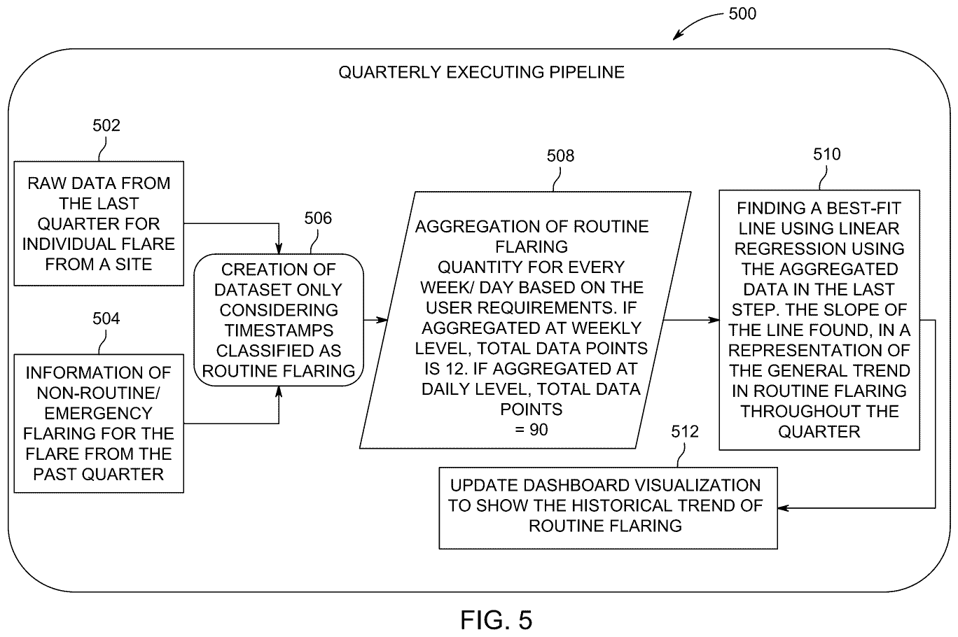

FIG. 5 illustrates a flowchart showing a method 500 for determining the baseline curve, in accordance with an example embodiment of the present disclosure. FIG. 5 is described in conjunction with FIGS. 1-2.

In some embodiments, the method 500 for determining the baseline curve may correspond to quarterly executing pipeline. At operation 502, the at least one processor 202 may be configured to receive raw data from a last quarter for an individual flare from the site. In some embodiments, the raw data may correspond to the historical flare data in the predefined time period. Simultaneously, at operation 504, the at least one processor 202 may be configured to receive information of non-routine or emergency flaring for the flare from the past quarter. At operation 506, the at least one processor 202 may be configured to create dataset only considering time stamps classified as routine flaring. The time stamps may correspond to one or more time stamps of the historical flare data. In some embodiments, the creation of dataset only considering time stamps classified as routine flaring may correspond to eliminating the one or more peaks from the historical flare data based at least on the one or more parameters associated with the one or more peaks. At operation 508, the at least one processor 202 may be configured to aggregate routine flaring quantity for every week or day based on the user requirements. In one instance, if aggregated at weekly level, total one or more points may be equal to 12. In another instance, if aggregated at daily level, total one or more points may be equal to 90.

At operation 510, the at least one processor 202 may be configured to find a best-fit line using linear regression using the aggregated data of the routine flaring. The slop of the line found, may be a representation of the general trend in routine flaring throughout the quarter. In some embodiments, the representation of the general trend in routine-flaring may correspond to the baseline curve, that is determined using the trained AI/ML model 206, based at least on the eliminated one or more peaks. At operation 512, the at least one processor 202 may be configured to update dashboard visualization to show the historical trend of routine flaring. The historical trend may be provided using the baseline curve.

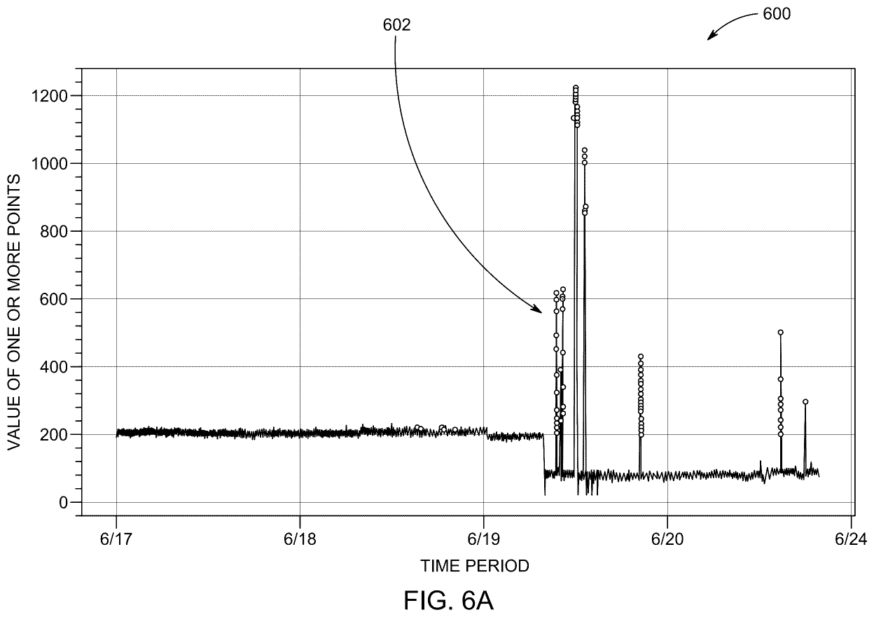

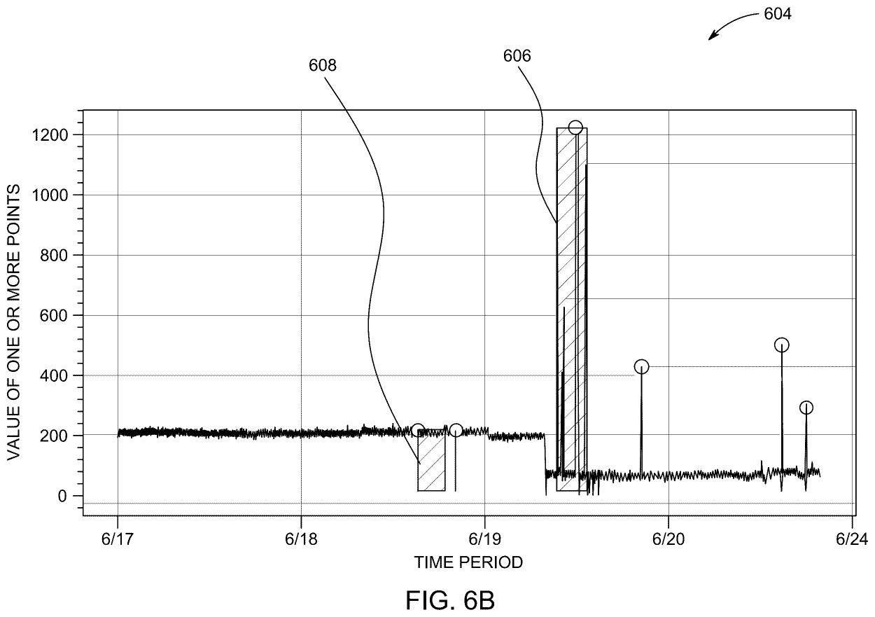

FIG. 6A illustrates a graph 600 showing the one or more peaks, in accordance with an example embodiment of the present disclosure. FIG. 6B illustrates a graph 604 showing one or more clusters, in accordance with an example embodiment of the present disclosure. FIGS. 6A-6B are described in conjunction with FIGS. 1-5.

In some embodiments, the graph 600 may represent the one or more points that are determined from the historical flare data using the trained AI/ML model 206, based at least on the threshold value. The x-axis of the graph 600 may represent a time period. The y-axis of the graph 600 may represent value of the one or more points. The one or more points may be represented with a dot for each of the one or more points, on a curve 602. In one example, the one or more points identified on the curve are filtered into the subset of points based at least on the one or more parameters. The one or more points may be filtered after every 24 hours. The one or more parameters may comprise at least one of median or standard deviation of values present within the historical flare data for the predefined time period.

Then, the filtered subset of points is clustered using the AI/ML model 206 to form the one or more clusters of the filtered subset of points. The subset of points may be clustered based at least on the one or more time stamps identified on the y-axis of the graph 600. Referring to FIG. 6B, the formed one or more clusters may be represented by the graph 604. The x-axis of the graph 604 may represent a time period. The y-axis of the graph 604 may represent the one or more clusters. In one example, a curve 606 represents a cluster of the one or more clusters. In another example, a curve 608 represents another cluster of the one or more clusters.

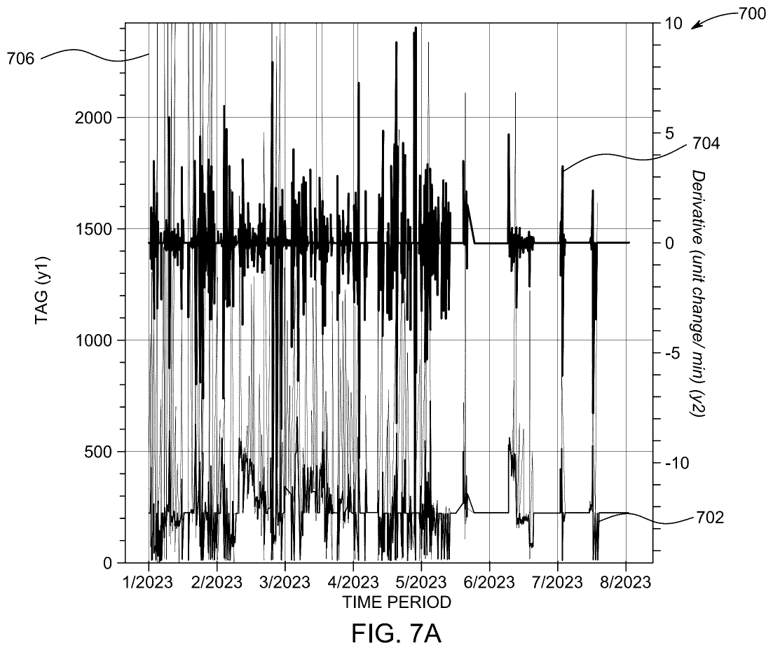

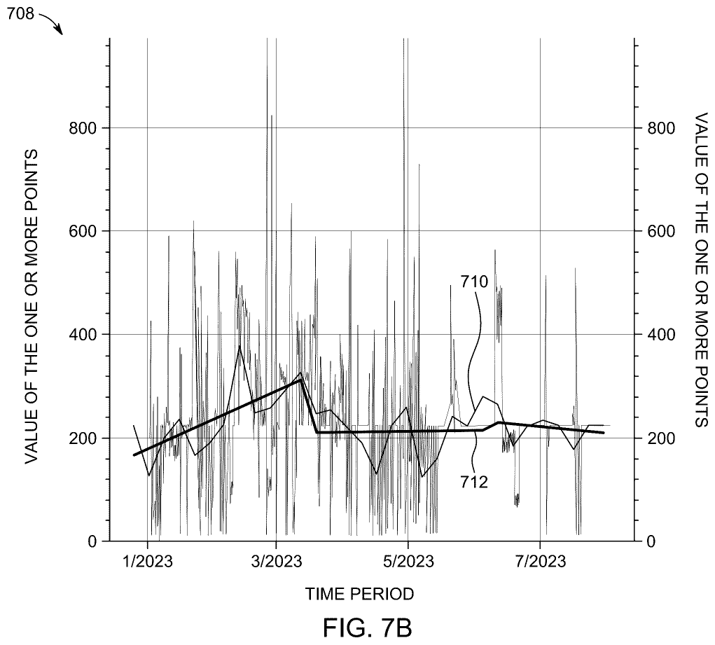

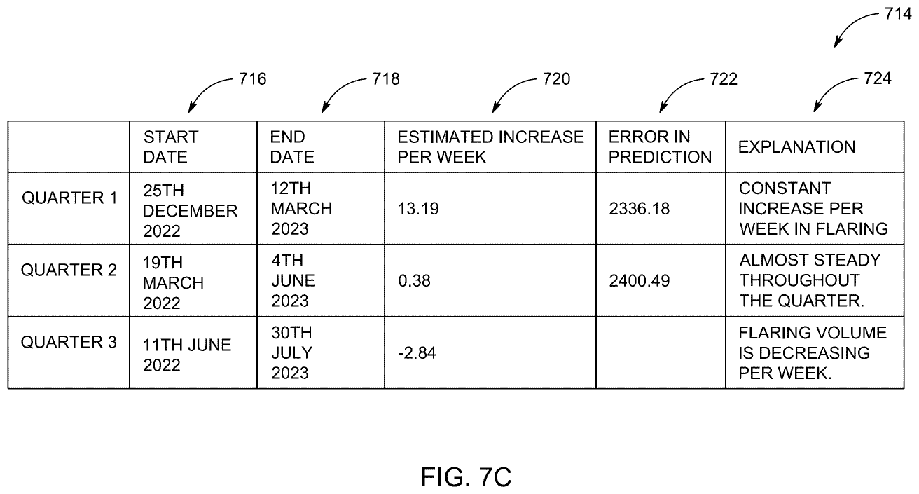

FIG. 7A illustrates a graph 700 showing an hourly monitoring, in accordance with an example embodiment of the present disclosure. FIG. 7A is described in conjunction with FIG. 4.

In some embodiments, the graph 700 may represent hourly monitoring of flaring using the trained AI/ML model 206. In some embodiments, the hourly executing pipeline, as described in FIG. 4, may be derived from the hourly monitoring by integrating real-time data inputs and executing predefined operations based on predictions generated by the trained AI/ML model 206. Further, the x-axis of the graph 700 may represent a time period. A first y-axis denoted as “y1” of the graph 700 may represent the tag indicating reading from one or more sensors associated with the one or more flare stacks 102, denoted as a “tag”. A second y-axis denoted as “y2” of the graph 700 may represent derivative corresponding to unit change per minute (min). In some embodiments, the historical flare data after eliminating the one or more peaks may be resampled at one hour intervals.

Further, a change in reading of the flow meter as compared to reading of the last hour is calculated. The change may be the derivative represented as “delta”. A high delta may correspond to a sudden shoot-in flaring during the hour, indicating increased flaring during the hour. In some embodiments, a curve 702 may indicate the flow meter's reading after removing the one or more peaks. Further, a curve 704 may indicate changes in the flaring or the delta. Furthermore, a curve 706 may indicate the original readings of the flow meter.

FIG. 7B illustrates a graph 708 showing a quarterly monitoring, in accordance with an example embodiment of the present disclosure. FIG. 7C illustrates a table 714 showing data related to the quarterly monitoring, in accordance with an example embodiment of the present disclosure. FIGS. 7B-7C are described in conjunction with FIG. 5.

In some embodiments, the graph 708 may represent quarterly monitoring of flaring using the trained AI/ML model 206. The quarterly monitoring of flaring may help to determine the baseline curve, as described in FIG. 5. The graph 708 may provide the best-fit line as the representation of the general trend in routine flaring throughout the quarter. The x-axis of the graph 708 may represent a time period. The y-axis of the graph 708 may represent value of the one or more points. In some embodiments, using the signal after removing the one or more peaks, quarterly monitoring may be done to identify trends, in flaring, across different quarters of the year. In one example, the historical flare data may be resampled at one week intervals, represented by a curve 710. Further, twelve points may be used to estimate a linear regression line i.e., a best-fit line or a baseline curve 712 translating to about twelve weeks or roughly three months. Further, the baseline curve 712 for the twelve points may reveal how the trend is during the quarter of the year.

Referring to FIG. 7B, the table 714 may represent data related to the quarterly monitoring of flaring using the trained AI/ML model 206. In some embodiments, the table 714 may represent data related to the quarterly monitoring of quarter 1, quarter 2, and quarter 3. The table 714 may comprise one or more columns as a start date 716, an end date 718, an estimated increase per week 720, an error in prediction 722, and an explanation 724. The start date 716 may indicate the beginning date of each quarter being monitored, providing a reference point for the period under review. The end date 718 may signify the conclusion date of the respective quarter, defining the duration of historical flare data collection and analysis. The estimated increase per week 720 may comprise calculated values representing the anticipated growth or change in a particular metric over each week within the quarter. The error in prediction 722 may record discrepancies between predicted and actual values, offering insights into the accuracy of the trained AI/ML model 206 deployed for quarterly monitoring. The explanation 724 may provide contextual details or notes explaining factors influencing the historical flare data or prediction derived from the quarterly monitoring using the trained AI/ML model 206, ensuring comprehensive understanding and interpretation of the quarterly data presented in the table 714.

In one example, for quarter 1, the table 714 may comprise the start date 716 as “25th December 2022”, the end date 718 as “12th March 2023”, “13.19” as the estimated increase per week 720, “2336.18” as the error in prediction 722, and may provide the explanation 724 as “Constant increase per week in flaring”.

In another example, for quarter 2, the table 714 may comprise the start date 716 as “19th March 2023”, the end date 718 as “4th June 2023”, “0.38” as the estimated increase per week 720, “2400.49” as the error in prediction 722, and may provide the explanation 724 as “Almost steady throughout the quarter”.

In yet another example, for quarter 3, the table 714 may comprise the start date 716 as “11th June 2023”, the end date 718 as “30th July 2023”, “−2.8” as the estimated increase per week 720, no error in prediction 722, and may provide the explanation 724 as “Flaring volume is decreasing per week”.

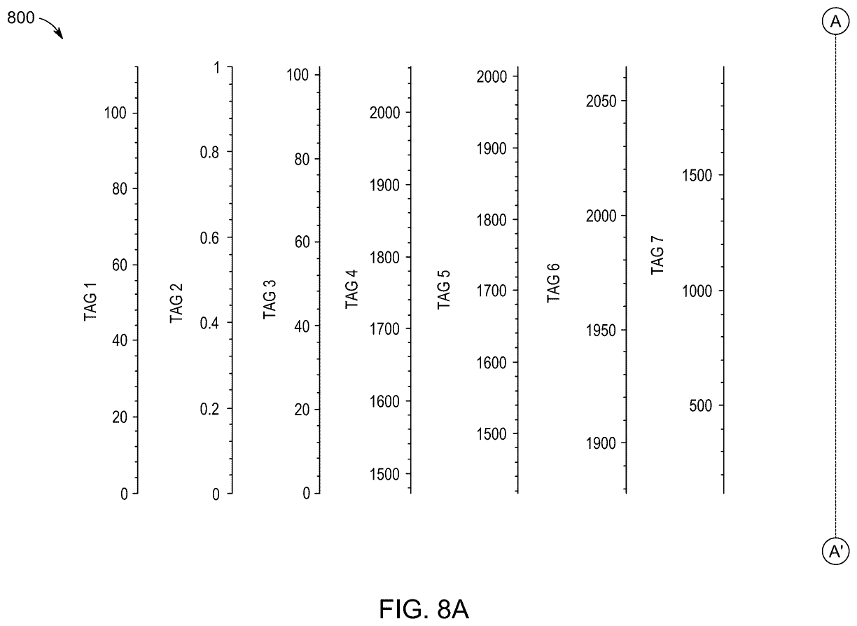

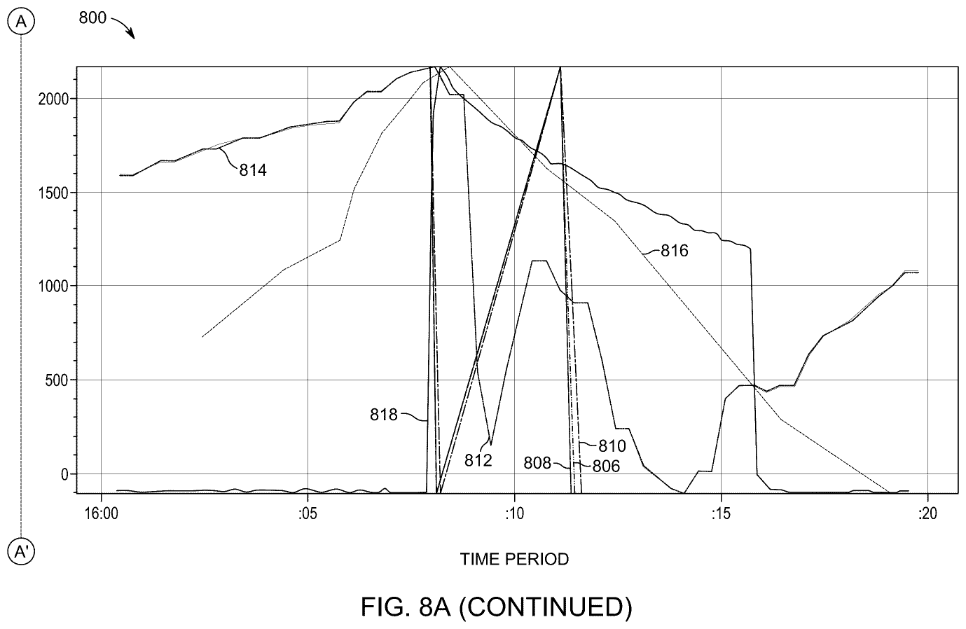

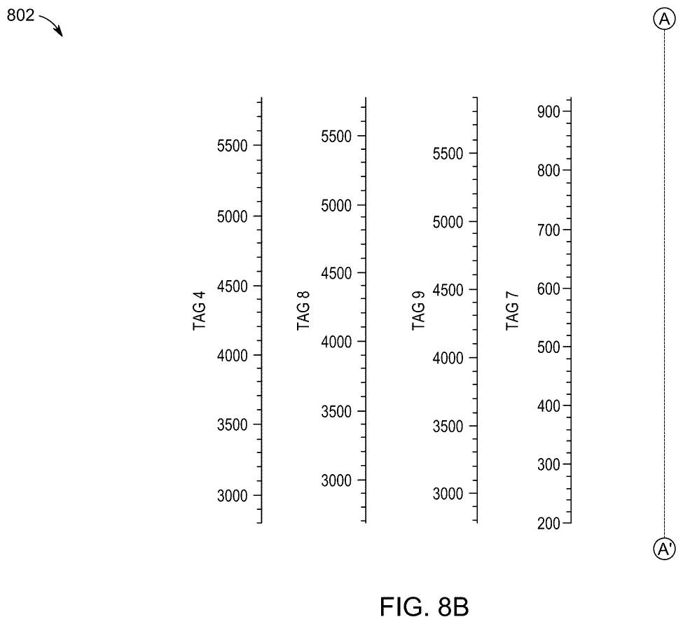

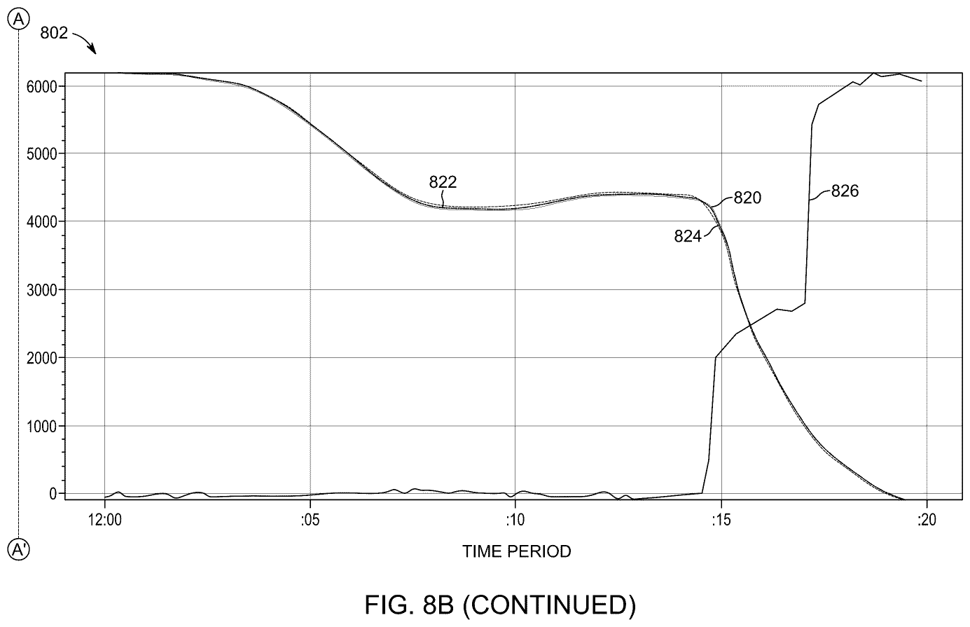

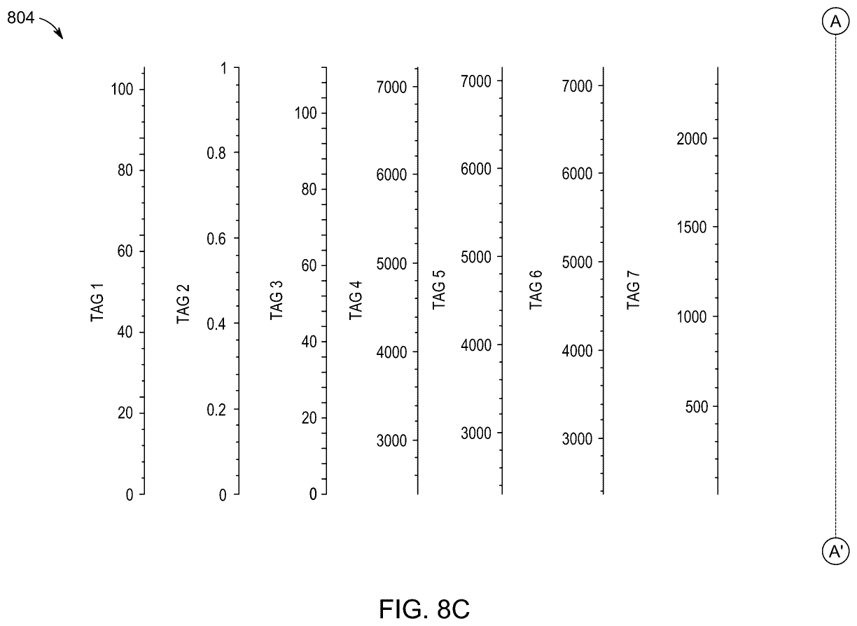

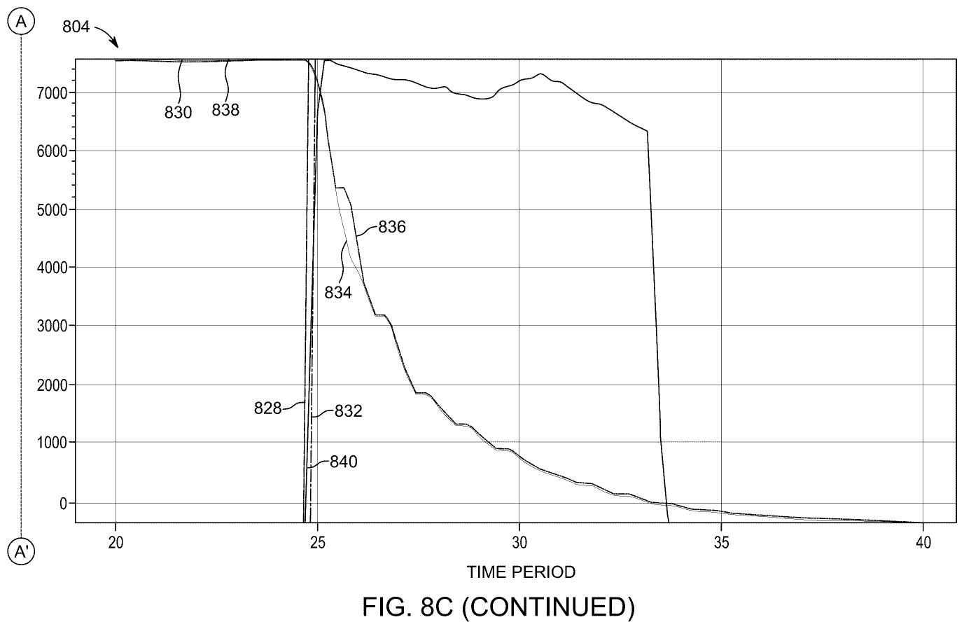

FIGS. 8A-8C illustrate graphs 800, 802, 804 showing emergency flaring, in accordance with an example embodiment of the present disclosure. FIGS. 8A-8C are described in conjunction with FIGS. 1-2.

In some embodiments, the graphs 800, 802, 804 may represent emergency flaring, determined using the trained AI/ML model 206 deployed on another site. The graph 800, 802, 804 may provide information on date, reactor, incident description, emergency flaring identification for determining the emergency flaring. In one example, a pressure tag, a kill tag and a flaring volume tag is used in each reactor of a plant for detecting emergency flaring. To find the emergency flaring, a change in the kill tag is observed, decrease in the pressure tag when there is the change in the kill tag is observed, and a peak in flaring volume tag, during the change in the kill tag, is observed.

Referring to FIG. 8A, the x-axis of the graph 800 may represent a time period. The y-axis of the graph 800 may represent value of a tag 1, a tag 2, a tag 3, a tag 4, a tag 5, a tag 6, and a tag 7. The graph 800 may comprise a curve 806, a curve 808, a curve 810, a curve 812, a curve 814, a curve 816, and a curve 818 for the tag 1, the tag 2, the tag 3, the tag 4, the tag 5, the tag 6, and the tag 7, respectively. In one example, for the date of Feb. 21, 2023 and the reactor “R-1B”, the curve 806, the curve 808, the curve 810, the curve 812, the curve 814, the curve 816, and the curve 818 may provide the incident description as “Operator was attempting to start R-1B after maintenance on the agitator belts. While attempting to start the reactor, the agitator amps dropped below 300, which engaged the kill switch (kill code: 102) on the agitator amps”. Further, based on the incident description, a change in the kill tag, the pressure tag and a peak in flaring volume tag, is observed. As a result, the emergency flaring is detected in the reactor R-1B.

Referring to FIG. 8B, the x-axis of the graph 802 may represent a time period. The y-axis of the graph 802 may represent value of the tag 4, a tag 8, a tag 9, and the tag 7. The graph 802 may comprise a curve 820, a curve 822, a curve 824, and a curve 826 for the tag 4, the tag 8, the tag 9, and the tag 7, respectively. In one example, for the date of May 3, 2023 and the reactor “R-1A”, the curve 820, the curve 822, the curve 824, and the curve 826 may provide the incident description as “RIA engaged safety manager kill code number 8. SIS and DCS trips”. Further, based on the incident description, a change in the kill tag, the pressure tag and a peak in flaring volume tag, is observed. As a result, the emergency flaring is detected in the reactor R-1A.

Referring to FIG. 8C, the x-axis of the graph 804 may represent a time period. The y-axis of the graph 804 may represent value of the tag 1, the tag 2, the tag 3, the tag 4, the tag 5, the tag 6, and the tag 7. The graph 804 may comprise a curve 828, a curve 830, a curve 832, a curve 834, a curve 836, a curve 838, and a curve 840 for the tag 1, the tag 2, the tag 3, the tag 4, the tag 5, the tag 6, and the tag 7, respectively. In one example, for the date of May 30, 2023 and the reactor “R-1B and R3”, the curve 828, the curve 830, the curve 832, the curve 834, the curve 836, the curve 838, and the curve 840, may provide the incident description as “PSV lifted during a loss of plant air due to water in the instrument air lines causing a cold shutdown of reactors”. Further, based on the incident description, a change in the kill tag, the pressure tag and a peak in flaring volume tag, is observed. As a result, the emergency flaring is detected in the reactor R-1B and R3.

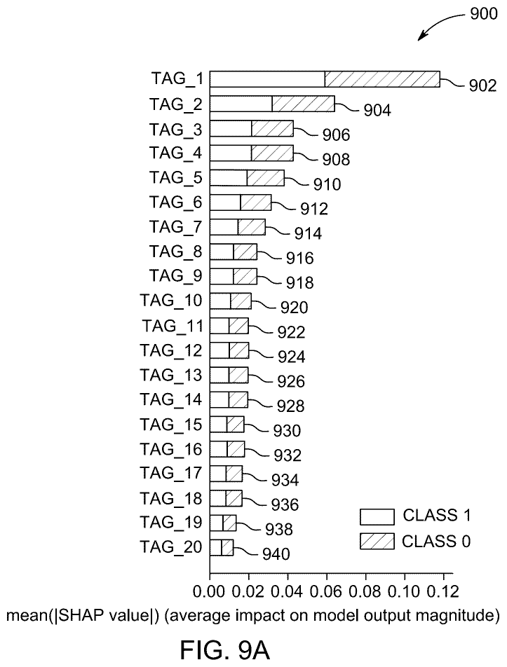

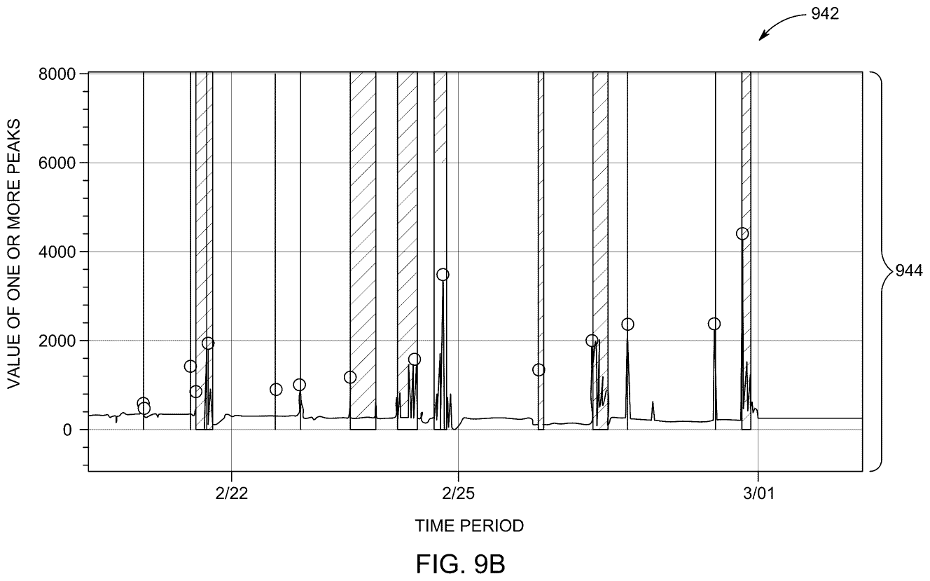

FIG. 9A illustrates a graph 900 showing shapely additive explanations (SHAP) plot for the trained AI/ML model 206, in accordance with an example embodiment of the present disclosure. FIG. 9A is described in conjunction with FIGS. 1-2.

In some embodiments, the graph 900 may represent the SHAP plot for one or more tags, during training of the AI/ML model 206. In some embodiments, the SHAP plot may be used in ML to interpret the output of the trained AI/ML model 206 by explaining the contribution of each tag of the one or more tags to individual predictions. The SHAP plot may leverage SHAP values, which are based on game theory and assign an importance score to each tag. The SHAP plot may display the importance score in a horizontal bar chart. In the SHAP plot, each tag may be represented along the y-axis and the SHAP value (indicating the average impact on model output magnitude) may be represented along the x-axis. The SHAP vale may be indicated as mean (SHAP value). Further, positive SHAP values may indicate one or more tags that increase the prediction, while negative values may show one or more values that decrease the prediction.

In some embodiments, the length of each bar may reflect the magnitude and direction of influence of each of the one or more tags on the prediction. The SHAP plot may identify one or more tags that are driving specific predictions. Further, the SHP plot may indicate the value of 1 for non-routine flaring by lighter region and the value of 0 for routine flaring by darker region of the graph 900. The value of 1 may come under class 1 for classification by the trained AI/ML model 206. The value of 0 may come under class 0 for classification by the trained AI/ML model 206.

In one example, a bar 902 may represent a SHAP plot for a tag “tag_1” corresponding to the tag indicating reading from one or more sensors associated with the one or more flare stacks 102, having the most influence on the prediction by the trained AI/ML model 206. In another example, a bar 904 may represent a SHAP plot for a tag “tag_2” corresponding to the tag indicating flare values. In yet another example, a bar 906 may represent a SHAP plot for a tag “tag_3”. In another example, a bar 908 may represent a SHAP plot for a tag “tag_4”. In yet another example, a bar 910 may represent a SHAP plot for a tag “tag_5”. In another example, a bar 912 may represent a SHAP plot for a tag “tag_6” corresponding to the tag indicating waste gas flow. In yet another example, a bar 914 may represent a SHAP plot for a tag “tag_7”. In another example, a bar 916 may represent a SHAP plot for a tag “tag_8”. In yet another example, a bar 918 may represent a SHAP plot for a tag “tag_9”. In another example, a bar 920 may represent a SHAP plot for a tag “tag_10” corresponding to the tag indicating liquid level of the flare. In yet another example, a bar 922 may represent a SHAP plot for a tag “tag_11”.

In another example, a bar 924 may represent a SHAP plot for a tag “tag_12” corresponding to the tag indicating temperature of the flare. In yet another example, a bar 926 may represent a SHAP plot for a tag “tag_13” corresponding to the tag indicating flare values. In another example, a bar 928 may represent a SHAP plot for a tag “tag_14”. In yet another example, a bar 930 may represent a SHAP plot for a tag “tag_15”. In another example, a bar 932 may represent a SHAP plot for a tag “tag_16”. In yet another example, a bar 934 may represent a SHAP plot for a tag “tag_17”. In another example, a bar 936 may represent a SHAP plot for a tag “tag_18”. In yet another example, a bar 938 may represent a SHAP plot for a tag “tag_19”. In another example, a bar 940 may represent a SHAP plot for a tag “tag_20”, having the least influence on the prediction by the trained AI/ML model 206.

FIG. 9B illustrates a graph 942 showing testing of the trained AI/ML model 206, in accordance with an example embodiment of the present disclosure. FIG. 9B is described in conjunction with FIGS. 1-2.

In some embodiments, the graph 942 may represent the testing result of the trained AI/ML model 206. The x-axis of the graph 942 may represent a time period. The time period may be represented as a time interval of days. The y-axis of the graph 942 may represent value of the one or more peaks. Each of the one or more peaks may be represented by the dots on a curve 944 of the graph 942. In one example, the historical flare data from 1st January to 30th April is used for testing the model performance to determine the one or more peaks.

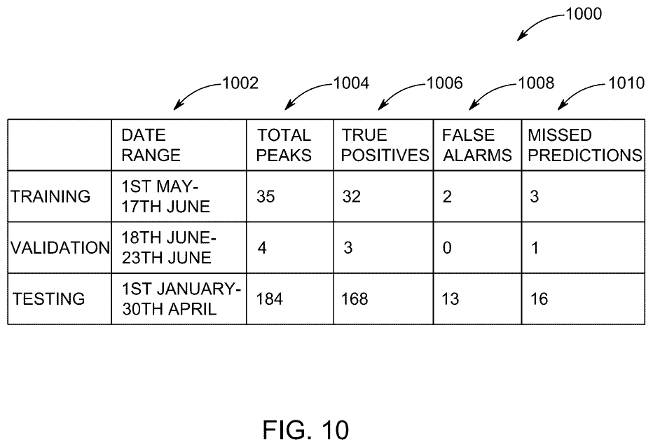

FIG. 10 illustrates a table 1000 showing training, validation, and testing results of the trained AI/ML model 206, in accordance with an example embodiment of the present disclosure.

In some embodiments, the table 1000 may represent one or more metrics for the trained AI/ML model 206 for training, testing, and validation. The table 1000 may comprise one or more metrics represented as one or more columns as a data range 1002, total peaks, 1004, true positives 1006, false alarms 1008, and missed predictions 1010. The data range 1002 may specify the period or range of dates during which performance of the trained AI/ML model 206 is assessed, providing a temporal context for the one or more metrics reported. The total peaks 1004 may refer to the aggregate number of flaring identified by the trained AI/ML model 206 during the specified data range, representing the total instances of the one or more peaks determined. The true positives 1006 may denote the number of correctly determined one or more peaks by the trained AI/ML model 206, indicating the accuracy in recognizing the flaring. The false alarms 1008 may record instances where the trained AI/ML model 206 may incorrectly identify the one or more peaks that do not correspond to actual flaring, highlighting potential areas for refinement in detection accuracy of the trained AI/ML model 206. The missed predictions 1010 may quantify the instances where the trained AI/ML model 206 may fail to detect the flaring, reflecting the sensitivity and identifying areas for improvement in ensuring comprehensive coverage of flaring. Together, the one or more metrics may provide an assessment of the performance of the trained AI/ML model 206 in terms of detection accuracy, reliability, and responsiveness across various operational phases of the flaring.

In one example, for training, the table 1000 may comprise the data range as “1st May-17th June”, the total peaks corresponding to 35, the true positives corresponding to 32, the false alarms corresponding to 2, and the missed predictions corresponding to 3. In another example, for validation, the table 1000 may comprise the data range as “18th June-23rd June”, the total peaks corresponding to 4, the true positives corresponding to 3, the false alarms corresponding to 0, and the missed predictions corresponding to 0. In yet another example, for testing, the table 1000 may comprise the data range as “1st January-30th April”, the total peaks corresponding to 184, the true positives corresponding to 168, the false alarms corresponding to 13, and the missed prediction corresponding to 16.

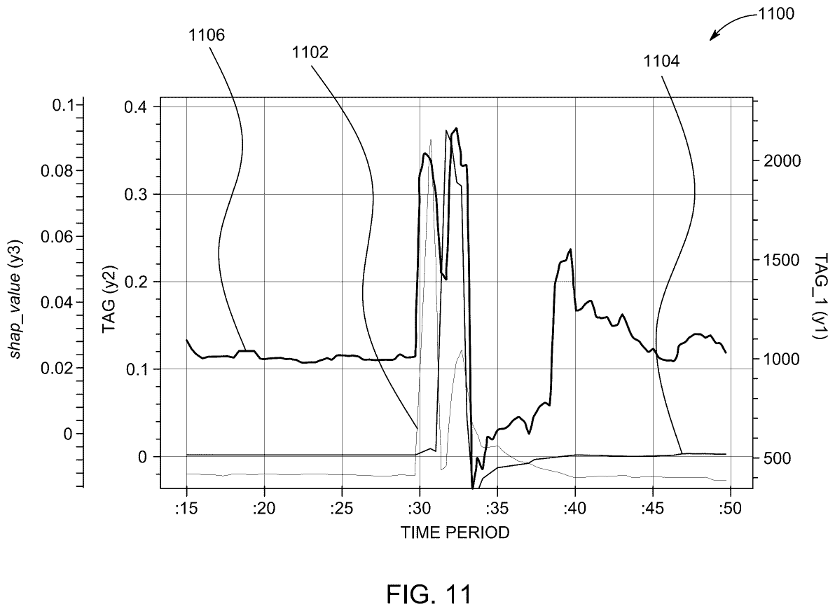

FIGS. 11-13 illustrate graphs 1100, 1200, 13000 showing SHAP values of one or more tags associated with the one or more peaks, in accordance with an example embodiment of the present disclosure. FIGS. 11-13 are described in conjunction with FIGS. 1-10.

In some embodiments, explaining the cause of a peak from the one or more peaks may be based on changes in SHAP values of the trained AI/ML model 206. For each of the one or more points, the SHAP values may be obtained. Further, using correlation analysis between readings of the flow meter and the SHAP values, the one or more tags may be ranked. In one example, higher correlation may indicate a true cause of the peak, from the one or more peaks, on the flow meter.

Referring to FIG. 11, the x-axis of the graph 1100 may represent a time period. A first y-axis denoted as “y1” of the graph 1100 may represent a value of the tag “tag_1”. A curve 1102 may represent the “tag_1”. A second y-axis denoted as “y2” of the graph 1100 may represent value of a tag corresponding to the tag indicating header pressure of the flare. A curve 1104 may represent the tag. A third y-axis denoted as “y3” of the graph 1100 may represent SHAP value of the tag of the second y-axis as “shap_value”. A curve 1106 may represent the SHAP value of the tag as “tag_shap_value”. In one example, the value of the tag increases from 0 to 0.4 and as a result, the SHAP value of the tag also increases.

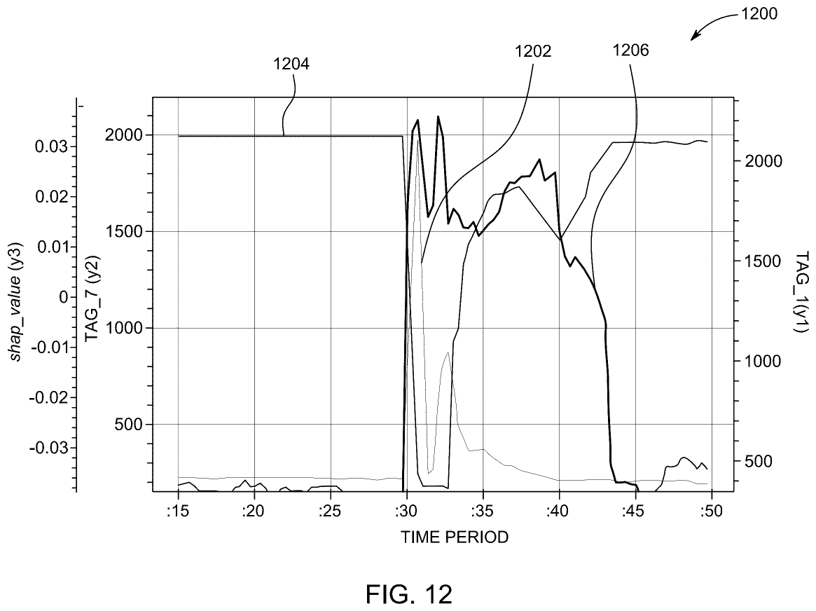

Referring to FIG. 12, the x-axis of the graph 1200 may represent a time period. A first y-axis denoted as “y1” of the graph 1200 may represent value of the tag “tag_1”. A curve 1202 may represent the tag “tag_1”. A second y-axis denoted as “y2” of the graph 1200 may represent value of the tag “tag_7”. A curve 1204 may represent the tag “tag_7”. A third y-axis denoted as “y3” of the graph 1200 may represent SHAP value of the tag “tag_7” as “shap_value”. A curve 1206 may represent the SHAP value of the tag “tag_7” as “tag_7_shap_value”. In one example, the value of the tag “tag_7” drops from 2000 to 500 units and is deemed an important tag by the trained AI/ML model 206.

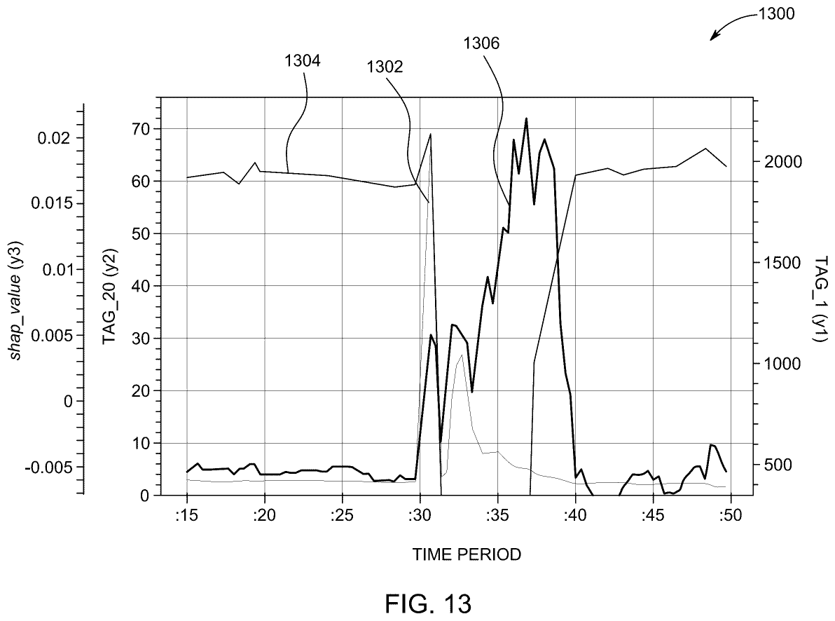

Referring to FIG. 13, the x-axis of the graph 1300 may represent a time period. A first y-axis denoted as “y1” of the graph 1300 may represent value of the tag “tag_1”. A curve 1302 may represent the tag “tag_1”. A second y-axis denoted as “y2” of the graph 1300 may represent value of the tag “tag_20”. A curve 1304 may represent the tag “tag_20”. A third y-axis denoted as “y3” of the graph 1100 may represent SHAP value of the tag “tag_7” as “shap_value”. A curve 1306 may represent the SHAP value of the tag “tag_7” as “tag_7_shap_value”. In one example, the value of the tag “tag_7” dropping, increased the importance of the trained AI/ML model 206.

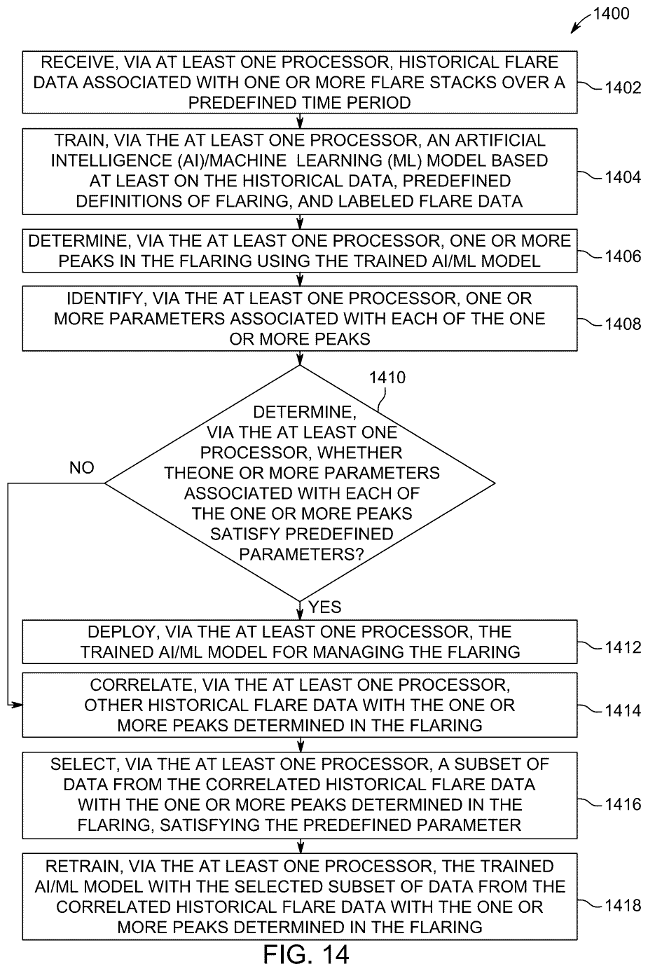

FIG. 14 illustrates a flowchart showing a method 1400 for training a machine learning (ML) model for peak detection in flaring, in accordance with an example embodiment of the present disclosure. FIG. 14 is described in conjunction with FIGS. 1-13.

At operation 1402, the at least one processor 202 may be configured to receive the historical flare data associated with the one or more flare stacks 102 over the predefined time period. The historical flare data may comprise at least one of the mass or volume of gas flared within each of the one or more flare stacks 102, the temperature of the gas flared, and the pressure at which the gas is flared. The predefined time period may comprise at least one of hours, days, months, quarters, or years.

For example, in an oil refinery with three flare stacks that have been monitored over the past five months. A historical flare data from the three flare stacks includes the mass of gas flared daily, with volumes ranging from 100 to 5000 cubic meters, temperature of the gas flared, between 300° C. and 800° C., and pressure at which the gas is flared, varying from 1 to 10 bar. The at least one processor 202 first collects the historical flare data, including sensor readings such as waste gas flow rates (ranging from 50 to 2000 cubic meters per hour), liquid levels in the flare stacks, header pressures, and flare temperatures.

At operation 1404, the at least one processor 202 may be configured to train the AI/ML model 206, based at least on the historical data, the predefined definitions of flaring, and the labeled flare data. The labeled flare data may correspond to tagging of peaks in flaring using the predefined value associated with the flaring. In some embodiments, the predefined definitions of flaring may correspond to the predefined meaning of the non-routine flaring and the emergency flaring occurred within the one or more flare stacks 102. In some embodiments, the at least one processor 202 may be configured to determine the emergency flaring or the non-routine flaring, using the trained AI/ML model 206. The emergency flaring or the non-routine flaring may be determined based at least on the predefined definitions of flaring. The emergency flaring may correspond to controlled burning of the gas in the flaring due to unexpected situation or emergency situation.

In some embodiments, the labeled flare data may correspond to the tagging of peaks in flaring using the predefined value associated with the flaring. The predefined value associated with the flaring may correspond to the value of 1 and the value of 0. In one example, the value of 1 may correspond to the non-routine flaring. In another example, the value of 0 may correspond to the routine flaring. In some embodiments, the labelled flare data may comprise one or more tags. Further, the one or more tags may comprise at least one of the tag indicating reading from one or more sensors associated with the one or more flare stacks 102, the tag indicating waste gas flow, the tag indicating liquid level of the flare, the tag indicating header pressure of the flare, the tag indicating temperature of the flare, or the tag indicating flare values.

In some embodiments, the at least one processor 202 may be configured to train the AI/ML model 206 by determining the one or more points from the historical flare data using the AI/ML model 206. The one or more points may be determined based at least on the threshold value. Further, the at least one processor 202 may be configured to train the AI/ML model 206 by filtering the subset of points from the determined one or more points based at least on the one or more parameters. The one or more parameters may comprise at least one of median or standard deviation of values present within the historical flare data for the predefined time period. Thereafter, the at least one processor 202 may be configured to train the AI/ML model 206 by clustering the filtered subset of points using the AI/ML model 206, to form the one or more clusters of the filtered subset of points. The filtered subset of points may be clustered based at least on one or more time stamps. The one or more clusters may comprise the one or more parameters. Further, the one or more parameters may comprise at least one of the group number, the start time, the end time, the duration, the peak time, or the flare quantity.

For example, the collected historic data is then used to train an AI/ML model 206, such as a random forest model and a DBSCAN model. The training process involves labeled flare data, where peaks in flaring are tagged. For instance, an event of non-routine flaring is tagged with a value of 1, while an event of routine flaring is tagged with a value of 0. Further, the at least one processor 202 identifies one or more points from the historical flare data that exceed a threshold value, say flaring where the gas volume surpasses 3000 cubic meters.

The one or more points are then filtered based on parameters such as the median and standard deviation of the historical data values present in the historical data over the five-month period to get a subset of points. For example, if the median flaring volume is 2500 cubic meters and the standard deviation is 700 cubic meters, the trained AI/ML model 206 filters out events that do not deviate significantly from these metrics. The filtered subset of points is clustered into groups using one or more time stamps, forming one or more clusters that detail events with specific start time, end time, duration, peak time, and flare quantity. For instance, a cluster might indicate a non-routine flaring event that started at 3:00 PM, peaked at 4:00 PM with a volume of 4000 cubic meters, and ended at 5:00 PM.

At operation 1406, the at least one processor 202 may be configured to determine the one or more peaks in the flaring using the trained AI/ML model 206. The one or more peaks may correspond to the maximum value of the peak exceeding the predefined threshold value of the peak for the predefined time period. For example, upon training the AI/ML model 206, the at least one processor 202 determines one or more peaks in the flaring that exceed a predefined threshold value, such as a peak flaring volume of 4500 cubic meters.

At operation 1408, the at least one processor 202 may be configured to identify the one or more parameters associated with each of the one or more peaks. In some embodiments, the one or more parameters associated with each of the one or more peaks may comprise at least one of start time and stop time of each of the one or more peaks. For example, one or more parameters associated with the peak flaring volume of 4500 cubic meters, including start time and stop time.

At operation 1410, the at least one processor 202 may be configured to determine whether the one or more parameters associated with each of the one or more peaks satisfy the predefined parameters. The predefined parameters may correspond to the minimum degree of accuracy that is acceptable for determining the non-routine flaring and the emergency flaring for the one or more flare stacks 102. In one instance, when the one or more parameters associated with each of the one or more peaks satisfy the predefined parameters, the at least one processor 202 may be configured to deploy the trained AI/ML model for managing the flaring upon determining the one or more parameters associated with each of the one or more peaks satisfy the predefined parameters, at operation 1412. In some embodiments, the at least one processor 202 may be configured to eliminate the one or more peaks from the historical flare data based at least on the one or more parameters associated with the one or more peaks. Thereafter, the at least one processor 202 may be configured to determine the baseline curve using the trained AI/ML model 206 for the predefined time period. The baseline curve may be determined based at least on the eliminated one or more peaks.

For example, the one or more parameters associated with the peak flaring volume of 4500 cubic meters are evaluated against predefined parameters. Once the trained AI/ML model 206 is adequately trained and the one or more parameters associated with the peak satisfy the minimum degree of accuracy, the trained AI/ML model 206 is deployed for managing flaring. The at least one processor 202 then eliminates identified one or more peaks from the historical flare data and determines a baseline curve for the predefined time period, such as the five months of data, using the trained AI/ML model 206.

In another instance, upon determining that the one or more parameters associated with each of the one or more peaks does not satisfy the predefined parameters, the at least one processor 202 may be configured to correlate the other historical flare data with the one or more peaks determined in the flaring, at operation 1414. At operation 1416, the at least one processor 202 may be configured to select the subset of data from the correlated historical flare data with the one or more peaks determined in the flaring, satisfying the predefined parameter. For example, if the one or more parameters do not meet the predefined parameters, the at least one processor 202 correlates additional historical flare data with the one or more peaks and selects a subset of data from the correlated historical flare data.

At operation 1418, the at least one processor 202 may be configured to retrain the trained AI/ML model 206 with the selected subset of data from the correlated historical flare data with the one or more peaks determined in the flaring. For example, the at least one processor 202 retrains the trained AI/ML model 206 with the selected subset of data.

Finally, the at least one processor 202 may utilize the trained AI/ML model 206 to identify emergency or non-routine flaring events based on predefined definitions of flaring. For example, an emergency flaring event, identified by a sudden spike in gas volume due to an unexpected situation like a safety valve release, can be distinguished from routine operational flaring. The method 1400 allows the oil refinery to manage flare stacks more effectively, reducing unnecessary flaring and improving environmental compliance.

In some embodiments, a non-transitory machine-readable information storage medium is disclosed. The non-transitory machine-readable information storage medium may comprise one or more instructions which when executed by at least one processor 202 cause the at least one processor 202 to receive the historical flare data associated with one or more flare stacks 102 over the predefined time period. The historical flare data may comprise at least one of mass or volume of gas flared within each of the one or more flare stacks 102, temperature of the gas flared, and pressure at which the gas is flared. Further, the non-transitory machine-readable information storage medium may comprise one or more instructions which when executed by the at least one processor 202 cause the at least one processor 202 to train the AI/ML model 206, based at least on the historical data, the predefined definitions of flaring, and the labeled flare data. The labeled flare data may correspond to tagging of peaks in flaring using the predefined value associated with the flaring.

Furthermore, the non-transitory machine-readable information storage medium may comprise one or more instructions which when executed by the at least one processor 202 cause the at least one processor 202 to determine the one or more peaks in the flaring using the trained AI/ML model 206. The one or more peaks may correspond to the maximum value of the peak exceeding the predefined threshold value of the peak for the predefined time period. Further, the non-transitory machine-readable information storage medium may comprise one or more instructions which when executed by the at least one processor 202 cause the at least one processor 202 to identify the one or more parameters associated with each of the one or more peaks. Furthermore, the non-transitory machine-readable information storage medium may comprise one or more instructions which when executed by the at least one processor 202 cause the at least one processor 202 to determine whether the one or more parameters associated with each of the one or more peaks satisfy the predefined parameters. Thereafter, the non-transitory machine-readable information storage medium may comprise one or more instructions which when executed by the at least one processor 202 cause the at least one processor 202 to deploy the trained AI/ML model for managing the flaring upon determining the one or more parameters associated with each of the one or more peaks satisfy the predefined parameters.

In some embodiments, the at least one processor 202 may be configured to train the AI/ML model 206 by determining one or more points from the historical flare data using the AI/ML model 206. The one or more points may be determined based at least on the threshold value. Further, the at least one processor 202 may be configured to train the AI/ML model 206 by filtering the subset of points from the determined one or more points based at least on the one or more parameters. The one or more parameters may comprise at least one of the median or the standard deviation of the values present within the historical flare data for the predefined time period. Thereafter, the at least one processor 202 may be configured to train the AI/ML model 206 by clustering the filtered subset of points using the AI/ML model 206, to form one or more clusters of the filtered subset of points. The filtered subset of points may be clustered based at least on one or more time stamps.

The present invention may accurately predict and identify flare peaks, thereby reducing overall flaring frequency and duration, by utilizing historical flare data encompassing gas mass/volume, temperature, and pressure, and using AI/ML models. The predictive capability of the system may not only optimize operational efficiency but also minimizes resource waste, leading to significant cost savings and improved asset utilization. Further, the AI/ML model may enable real-time monitoring and response to flare events, enhancing safety and regulatory compliance by promptly alerting operators to deviations from predefined parameters. The system may ensure environmental sustainability by minimizing greenhouse gas emissions through proactive flare management strategies. Further, leveraging data-driven insights may enhance decision-making processes, allowing operators to adjust operations swiftly based on predictive analytics on the flares. Compliance with environmental regulations may be assured through continuous monitoring and adherence to predefined flaring standards. The system may provide heightened operational reliability, as AI/ML models enable proactive maintenance and optimization of flare stack performance. The deployment of AI/ML for flare management may commit to innovation and technological advancement in industrial operations, fostering a more sustainable and efficient approach to energy management.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, via at least one processor, historical flare data associated with one or more flare stacks over a predefined time period, wherein the historical flare data comprises at least one of mass or volume of gas flared within each of the one or more flare stacks, temperature of the gas flared, and pressure at which the gas is flared;
training, via the at least one processor, an artificial intelligence (AI)/machine learning (ML) model, based at least on the historical data, predefined definitions of flaring, and labeled flare data, wherein the labeled flare data correspond to tagging of peaks in flaring using a predefined value associated with the flaring;
determining, via the at least one processor, one or more peaks in the flaring using the trained AI/ML model, wherein the one or more peaks correspond to a maximum value of a peak exceeding a predefined threshold value of the peak for the predefined time period;
identifying, via the at least one processor, one or more parameters associated with each of the one or more peaks;
determining, via the at least one processor, whether the one or more parameters associated with each of the one or more peaks satisfy predefined parameters; and
deploying, via the at least one processor, the trained AI/ML model for managing the flaring upon determining the one or more parameters associated with each of the one or more peaks satisfy the predefined parameters.

2. The method of claim 1, wherein the at least one processor is configured to train the AI/ML model by:
determining, via the at least one processor, one or more points from the historical flare data using the AI/ML model, based at least on a threshold value;
filtering, via the at least one processor, a subset of points from the determined one or more points based at least on one or more parameters, wherein the one or more parameters comprise at least one of median or standard deviation of values present within the historical flare data for the predefined time period; and
clustering, via the at least one processor, the filtered subset of points using the AI/ML model, based at least on one or more time stamps, to form one or more clusters of the filtered subset of points.

3. The method of claim 2, wherein the one or more clusters having one or more parameters, and wherein the one or more parameters comprise at least one of a group number, a start time, an end time, duration, peak time, or flare quantity.

4. The method of claim 1, wherein the labelled flare data comprises one or more tags, wherein the one or more tags comprise at least one of tag indicating reading from one or more sensors associated with the one or more flare stacks, tag indicating waste gas flow, tag indicating liquid level of the flare, tag indicating header pressure of the flare, tag indicating temperature of the flare, or tag indicating flare values.

5. The method of claim 1, wherein the predefined definitions of flaring correspond to a predefined meaning of a non-routine flaring and an emergency flaring occurred within the one or more flare stacks, and wherein the predefined parameters correspond to a minimum degree of accuracy that is acceptable for determining the non-routine flaring and the emergency flaring for the one or more flare stacks, and wherein the one or more parameters associated with each of the one or more peaks comprise at least one of start time and stop time of each of the one or more peaks.

6. The method of claim 5 further comprising determining, via the at least one processor, the emergency flaring or the non-routine flaring, using the trained AI/ML model based at least on the predefined definitions of flaring, and wherein the emergency flaring corresponds to controlled burning of gas in the flaring due to unexpected or emergency situation.

7. The method of claim 6 further comprising:
correlating, via the at least one processor, other historical flare data with the one or more peaks determined in the flaring upon determining the one or more parameters associated with each of the one or more peaks does not satisfy the predefined parameters;
selecting, via the at least one processor, a subset of data from the correlated historical flare data with the one or more peaks determined in the flaring, satisfying the predefined parameters; and
retraining, via the at least one processor, the trained AI/ML model with the selected subset of data from the correlated historical flare data with the one or more peaks determined in the flaring.

8. The method of claim 1 further comprising:
eliminating, via the at least one processor, the one or more peaks from the historical flare data based at least on the one or more parameters associated with the one or more peaks; and
determining, via the at least one processor, a baseline curve using the trained AI/ML model for the predefined time period, based at least on the eliminated one or more peaks.

9. The method of claim 1, wherein the predefined value associated with the flaring corresponds to a value of 1 for non-routine flaring and a value of 0 for routine flaring, and wherein the predefined time period comprises at least one of hours, days, months, quarters, or years.

10. A system comprising:
a memory; and
at least one processor communicatively coupled to the memory, wherein the at least one processor is configured to:
receive historical flare data associated with one or more flare stacks over a predefined time period, wherein the historical flare data comprises at least one of mass or volume of gas flared within each of the one or more flare stacks, temperature of the gas flared, and pressure at which the gas is flared;
train an artificial intelligence (AI)/machine learning (ML) model, based at least on the historical data, predefined definitions of flaring, and labeled flare data, wherein the labeled flare data correspond to tagging of peaks in flaring using a predefined value associated with the flaring;
determine one or more peaks in the flaring using the trained AI/ML model, wherein the one or more peaks correspond to a maximum value of a peak exceeding a predefined threshold value of the peak for the predefined time period;
identify one or more parameters associated with each of the one or more peaks;
determine whether the one or more parameters associated with each of the one or more peaks satisfy predefined parameters; and
deploy the trained AI/ML model for managing the flaring upon determining the one or more parameters associated with each of the one or more peaks satisfy the predefined parameters.

11. The system of claim 10, wherein the at least one processor is configured to train the AI/ML model by:
determining one or more points from the historical flare data using the AI/ML model, based at least on a threshold value;
filtering a subset of points from the determined one or more points based at least on one or more parameters, wherein the one or more parameters comprise at least one of median or standard deviation of values present within the historical flare data for the predefined time period; and
clustering the filtered subset of points using the AI/ML model, based at least on one or more time stamps, to form one or more clusters of the filtered subset of points.

12. The system of claim 11, wherein the one or more clusters having one or more parameters, and wherein the one or more parameters comprise at least one of a group number, a start time, an end time, duration, peak time, or flare quantity.

13. The system of claim 10, wherein the labelled flare data comprises one or more tags, wherein the one or more tags comprise at least one of tag indicating reading from one or more sensors associated with the one or more flare stacks, tag indicating waste gas flow, tag indicating liquid level of the flare, tag indicating header pressure of the flare, tag indicating temperature of the flare, or tag indicating flare values.

14. The system of claim 10, wherein the predefined definitions of flaring correspond to a predefined meaning of a non-routine flaring and an emergency flaring occurred within the one or more flare stacks, and wherein the predefined parameters correspond to a minimum degree of accuracy that is acceptable for determining the non-routine flaring and the emergency flaring for the one or more flare stacks, and wherein the one or more parameters associated with each of the one or more peaks comprise at least one of start time and stop time of each of the one or more peaks.

15. The system of claim 14, wherein the at least one processor is configured to determine the emergency flaring or the non-routine flaring, using the trained AI/ML model based at least on the predefined definitions of flaring, and wherein the emergency flaring corresponds to controlled burning of gas in the flaring due to unexpected or emergency situation.

16. The system of claim 15, wherein the at least one processor is configured to:
correlate other historical flare data with the one or more peaks determined in the flaring upon determining the one or more parameters associated with each of the one or more peaks does not satisfy the predefined parameters;
select a subset of data from the correlated historical flare data with the one or more peaks determined in the flaring, satisfying the predefined parameters; and
retrain the trained AI/ML model with the selected subset of data from the correlated historical flare data with the one or more peaks determined in the flaring.

17. The system of claim 10, wherein the at least one processor is configured to:
eliminate the one or more peaks from the historical flare data based at least on the one or more parameters associated with the one or more peaks; and
determine a baseline curve using the trained AI/ML model for the predefined time period, based at least on the eliminated one or more peaks.

18. The system of claim 10, wherein the predefined value associated with the flaring corresponds to a value of 1 for non-routine flaring and a value of 0 for routine flaring, and wherein the predefined time period comprises at least one of hours, days, months, quarters, or years.

19. A non-transitory machine-readable information storage medium comprising one or more instructions which when executed by at least one processor cause the at least one processor to:
receive historical flare data associated with one or more flare stacks over a predefined time period, wherein the historical flare data comprises at least one of mass or volume of gas flared within each of the one or more flare stacks, temperature of the gas flared, and pressure at which the gas is flared;
train an artificial intelligence (AI)/machine learning (ML) model, based at least on the historical data, predefined definitions of flaring, and labeled flare data, wherein the labeled flare data correspond to tagging of peaks in flaring using a predefined value associated with the flaring;
determine one or more peaks in the flaring using the trained AI/ML model, wherein the one or more peaks correspond to a maximum value of a peak exceeding a predefined threshold value of the peak for the predefined time period;
identify one or more parameters associated with each of the one or more peaks;
determine whether the one or more parameters associated with each of the one or more peaks satisfy predefined parameters; and
deploy the trained AI/ML model for managing the flaring upon determining the one or more parameters associated with each of the one or more peaks satisfy the predefined parameters.

20. The non-transitory machine-readable information storage medium of claim 19, wherein the at least one processor is configured to train the AI/ML model by:
determining one or more points from the historical flare data using the AI/ML model, based at least on a threshold value;
filtering a subset of points from the determined one or more points based at least on one or more parameters, wherein the one or more parameters comprise at least one of median or standard deviation of values present within the historical flare data for the predefined time period; and
clustering the filtered subset of points using the AI/ML model, based at least on one or more time stamps, to form one or more clusters of the filtered subset of points.
